(19) United States
(12) Patent Application Publication
(10) Pub. No.: US 2018/0191643 A1
(43) Pub. Date: Jul. 5, 2018

(54) USER COMMUNICATIONS WITH A THIRD PARTY THROUGH A SOCIAL NETWORKING SYSTEM

(71) Applicant: Facebook, Inc., Menlo Park, CA (US)

(72) Inventors: Lior Berry, Sunnyvale, CA (US); Pradeep Venkatachalam, Mountain View, CA (US); Jyotika Prasad, Santa Clara, CA (US)

(21) Appl. No.: 15/395,543

(22) Filed: Dec. 30, 2016

(51) Int. Cl. H04L 12/58; H04L 29/08

(52) U.S. Cl. CPC H04L 51/02; H04L 67/02; H04L 51/32; H04L 51/04; H04L 67/20

(57) ABSTRACT

The present disclosure is directed toward systems and methods for facilitating communications between a third party and a user of a social networking system. The systems and methods may include providing, via a social networking system, an electronic form having at least one fillable field and receiving one or more responses from the user via the electronic form. The systems and methods may also include generating a communication thread between the third party and the user and, based on the one or more responses received from the user, customizing one or more messages to the user. The systems and methods further include triggering, based the one or more responses received from the user, a notification to the third party and facilitating continued communication between the user and the third party via the communication thread.

### BACKGROUND

Due to the increasing popularity of online shopping, merchants are continually trying to find ways to effectively communicate with and foster (e.g., generate) potential online customers to provide assistance and lead to sales. One way merchants often try to communicate with potential online customers is through email. However, communicating with potential customers via email has a number of disadvantages. For example, emails are often sent long after the potential online customer expresses an initial interest in the merchant, and thus, an opportunity to discuss the potential customer's interest in relative proximity to when the potential online customer expressed the interest is missed. In other words, by the time the email is received, an opportunity to develop a customer is past. Furthermore, due to increased threats in electronic security, users often view emails as potentially suspect (e.g., having viruses) and avoid opening emails. Moreover, users often view email communication as impersonal and discard emails without even opening them.

Another way merchants often try to communicate with potential online customers is via telephone. However, potential online customers typically do not want the pressure involved with a phone call when expressing interest in a merchant and, for those reasons, are unwilling to provide their phone numbers to a merchant.

Moreover, merchants often waste valuable resources on potential online customers that are not ready or prepared to make any kind of purchase or commitment. In other words, the potential online customers are merely “window shoppers,” and the merchants waste time and energy trying to develop a customer that is uninterested in becoming and, ultimately, unwilling to become a customer.

Thus, traditional systems and methods for contacting potential customers suffer from a number of time-consuming and inefficient disadvantages.

### SUMMARY

One or more embodiments described herein provide benefits and/or solve one or more of the foregoing or other problems in the art with systems and methods for a third party (e.g., a merchant) to effectively communicate with a social networking user (e.g., a customer). Particularly, some embodiments of the present disclosure include systems and methods for enabling the user to optionally request to communicate directly with the third party via an application such as messaging application while expressing interest in the third party. Thus, because the systems and methods allow a user to optionally request to communicate directly with the third party via a messaging application, the systems and methods facilitate a more personal, a more immediate, but less pressuring method to communicate with potential customers who may be interested in a product.

Additional embodiments of the present disclosure include systems and methods for initially communicating with the user via the messaging application, which includes automatically customizing messages to the user based on one or more previously received responses from the user. In other words, the systems and methods initially communicate with the user via a bot (e.g., an application that automatically communicates with the user). Furthermore, upon determining that the user is ready to communicate with the third party (e.g., ready to communicate with a human administrator or representative of the third party), the system and methods enable direct communication between the user and the third party. Thus, because the systems and methods initially communicate with the user via a messaging application and determine when the user is ready to communicate with the third party, the systems and methods provide a personal method to communicate with the user while assisting the third party in not wasting resources prior to the user being ready to communicate with the third party and/or proceed with a purchase.

One or more embodiments of the present disclosure include systems and methods for tagging a communication thread between the user and the third party with tags indicating particular aspects (e.g., a particular situation, one or more conditions, and/or a preparedness to communicate directly with the third party) of the communication thread. Furthermore, the disclosed systems and methods can then utilize the communication thread tags to, for example, prioritize communication threads and/or the use of resources in communicating with the users.

Additional features and advantages of the present invention will be set forth in the description that follows, and in part will be obvious from the description, or may be learned by the practice of such example embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe the manner in which the above recited and other advantages and features can be obtained, a more particular description of the aspects of one or more embodiments briefly described above will be rendered by reference to specific embodiments thereof that are illustrated in the appended drawings. It should be noted that the figures are not drawn to scale, and that elements of similar structure or function are generally represented by like reference numerals for illustrative purposes throughout the figures. Understanding that these drawings depict only typical embodiments and are not therefore to be considered to be limiting of scope, one or more embodiments of the invention will be described and explained with additional specificity and detail through the use of the accompanying drawings in which:

FIG. 1 illustrates a schematic diagram of an environment for implementing a communication system according to one or more embodiments of the present disclosure;

FIGS. 2A-2D illustrate a sequence-flow diagram illustrating interactions in a communication process between a user, a social networking system, and a third party according to one or more embodiments of the present disclosure;

FIGS. 3A-3E illustrate a flow of user interfaces including features of the communication system in accordance with one or more embodiments;

FIG. 4 illustrates a schematic representation of a logic flow diagram for customizing automated messages to a user according to one or more embodiments of the present disclosure;

FIG. 5 shows a method flow of facilitating communications between a user and a third party via a social networking system according to an embodiment of the present disclosure;

FIG. 6 illustrates a block diagram of an exemplary computing device in accordance with one or more embodiments;

FIG. 7 illustrates an example network environment of a social networking system in accordance with one or more embodiments; and

FIG. 8 illustrates a social graph in accordance with one or more embodiments.

### DETAILED DESCRIPTION

Embodiments of the present disclosure include a social networking system that provides content (e.g., promotional offers) associated with a third party (e.g., a merchant) to a user (e.g., potential customer) of the social networking system and generating a communication thread between the user and the third party. In additional embodiments, the social networking system initially automatically communicates (e.g., via a Bot) with the user via the communication thread. In further embodiments, the social networking system determines when the user is prepared (e.g., ready) to communicate directly with the third party and enables communication between the user and the third party via the communication thread. In yet further embodiments, the social networking system tags the communication thread with tags indicating aspects of the communication thread and then utilizes the tags to facilitate management of the communication thread.

As noted above, the social networking system provides content associated with a third party to a user of the social networking system and generates a communication thread between the user and the third party. In particular, the social networking system provides the content to the user via a social networking application (e.g., mobile or web-based) of the social networking system. In some embodiments, the social networking system provides the content to the user within a newsfeed associated with the user. Furthermore, in response to a request from the user, the social networking system can generate a communication thread between the user and the third party. For example, the social networking system can generate a communication thread for communicating using a messaging application (e.g., a messaging application associated with the social networking system).

Because the social networking system utilizes a messaging application to communicate with the user and facilitate communications between the user and the third party, the social networking system provides a more personal and immediate method of communication between the user and the third party in comparison to conventional communication systems (e.g., email). Furthermore, because the social networking system generates a communication thread between the user and the third party within a messaging application, the social networking system provides a less pressuring and less stressful environment for the user and the third party to communicate in comparison to conventional communication systems (e.g., telephone calls). In view of the foregoing, the social networking system can obtain an increased number of communications between users and the third party, and as a result, may result in additional sales and revenue for the third party in comparison to conventional communication systems.

As mentioned briefly above, in addition providing content and generating a communication thread, the social networking system initially automatically communicates with the user via the communication thread (e.g., the messaging application). In particular, the social networking system can initially communicate with the user via the communication thread utilizing a bot and may not initially enable to the user to communicate directly with the third party.

Because the social networking system can initially communicate with the user via the bot, the social networking system can determine whether the user is a legitimate potential customer prior to putting the user in direct communication with the third party. In other words, the social networking system can separate (e.g., weed out) passive users from the legitimate potential customers. As a result, the social networking system helps the third party to direct its resources to legitimate potential customers instead of users that are unlikely to become customers. In view of the foregoing, the social networking system may result in more effective communications between the user and the third party in comparison to conventional communication systems. As a result, the social networking system may result in additional sales and revenue for the third party in comparison to conventional communication systems.

As discussed above, the social networking system can determine when the user is prepared to communicate directly with the third party. For example, the social networking system can determine when the user is ready to make a purchase or is in need of additional assistance from the third party (e.g., from a human associate of the third party). Furthermore, based on received responses from the user, the social networking system can customize messages to the user and through such a process can acquire additional information from the user. Put another way, the social networking system can customize each subsequent message to the user based on one or more previously received responses from the user.

Because the social networking system can customize messages to the user based on previously received responses from the user, and because the social networking system can acquire additional information from the user, the social networking system can, based on the responses from the user, determine a most opportune time to put the user in communication with the third party (e.g., when the user is ready to make a purchase). As a result, the social networking system of the present disclosure may provide more effective communications between the user and the third party in comparison to conventional communication systems.

Furthermore, because the social networking system can determine a most opportune time to put the user in communication with the third party, the social networking system may reduce a duration in which multiple applications are necessarily concurrently operating within the social networking system and/or user device. Furthermore, by avoiding direct communication between the user and the third party until the user is prepared to communicate with the third party, the social networking system may reduce required processing capabilities, power, and memory of the user device and social networking system.

An additional advantage provided by social networking system over conventional communication systems is that, by communicating with the user initially and customizing messages to the user based on previously received responses from the user, the social networking system can more readily determine whether the user is a bot (e.g., fraud user). Accordingly, upon determining that the user is a bot, the social networking system can avoid facilitating further communication between the fraudulent user and the third party.

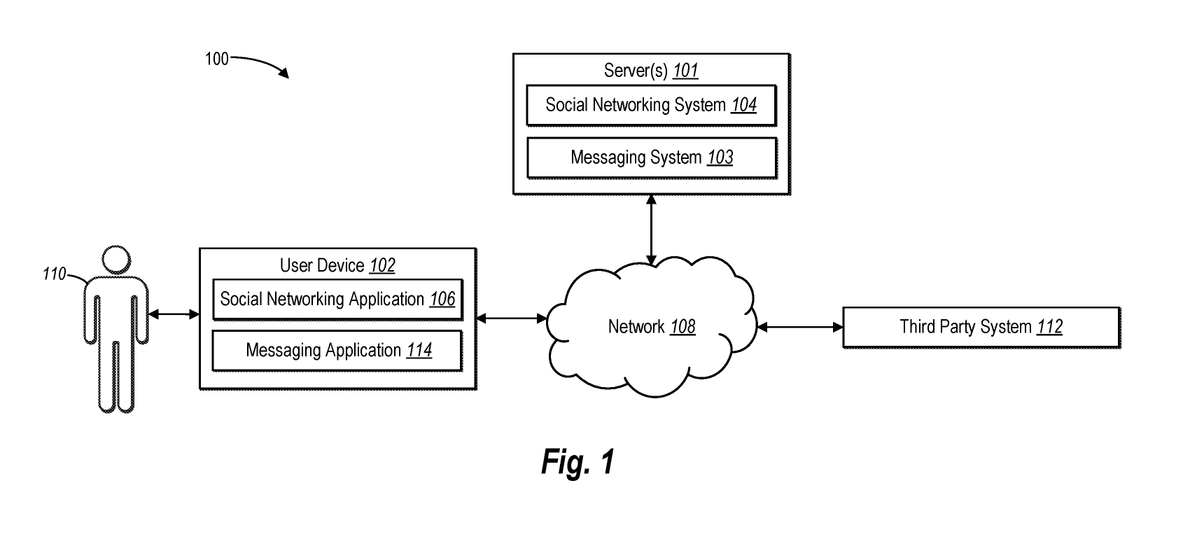

FIG. 1 illustrates a schematic diagram of a communication system 100 according to an embodiment of the present disclosure. As shown in FIG. 1, the communication system 100 may include various components for performing the processes and features described herein. For example, the communication system 100 includes at least one user device 102, one or more server(s) 101, and a third party system 112, which are communicatively coupled through a network 108. As used herein, the term “social networking system” refers to a system that supports and enables on-line communication, input, interaction, content sharing, and collaboration between users. Also as illustrated in FIG. 1, a user 110 interacts with the user device 102 in order to access content and/or services on or provided by the social networking system 104.

In one or more embodiments, the one or more server(s) 101 may include (e.g., host) a social networking system 104 and/or a messaging system 103 (e.g., a server-level messaging system 103). In some instances, the messaging system 103 may be part of the social networking system 104. In alternative embodiments, the messaging system 103 may be separate from the social networking system 104 and hosted by separate servers than the social networking system 104. Furthermore, although the social networking system 104 and the messaging system 103 are illustrated on a same server 101, the social networking system 104 and the messaging system 103 may be on separate servers 101. As will be discussed in greater detail below, in some embodiments, the messaging system 103 may facilitate communication between a user 110 and the third party system 112.

In some embodiments, the user device 102 may include a social networking application 106 associated with the social networking system 104. The social networking application 106 of the user device 102 accesses the social networking system 104 via the network 108. In one or more embodiments, the social networking application 106 can be a native application installed on the user device 102. For example, the social networking application 106 may be a mobile application that installs and runs on a mobile device, such as a smart phone or a tablet. Alternatively, the social networking application 106 can be a desktop application, widget, or other form of a native computer program. Alternatively, the social networking application 106 may be a remote application accessed by the user device 102. For example, the social networking application 106 may be a web application that is executed within a web browser of the client device 104.

In one or more embodiments, as illustrated in FIG. 1, the user device 102 includes a messaging application 114 for facilitating communication (e.g., reading, composing, and/or sending messages) between the user 110 and the third party. In some embodiments, the messaging application 114 can be separate from the social networking application 106 and/or associated with a separate electronic messaging system (i.e., separate from the social networking system 104). In other embodiments, although illustrated as being separate in FIG. 1, the messaging application 114 can be associated with and/or part of the social networking application 106. In other words, the messaging application 114 can be associated with the social networking system 104. Furthermore, in some instances, the messaging application 114 can be an electronic messaging application (e.g., a messenger, chat application, text messenger, etc.).

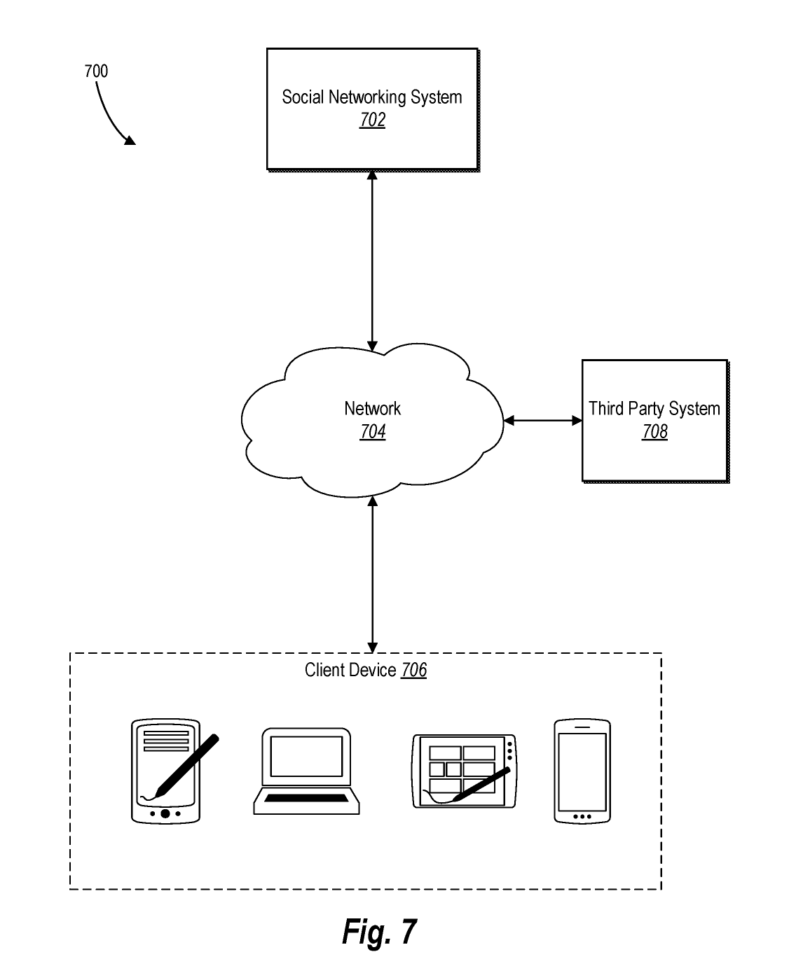

The user device 102, the social networking system 104, and the third party system 112 communicate via the network 108, which may include one or more networks and may use one or more communication platforms or technologies suitable for transmitting data and/or communication signals. In one or more embodiments, the network 108 includes the Internet or World Wide Web. The network 108, however, can include various other types of networks that use various communication technologies and protocols, such as a corporate intranet, a virtual private network (VPN), a local area network (LAN), a wireless local network (WLAN), a cellular network, a wide area network (WAN), a metropolitan area network (MAN), or a combination of two or more such networks. Although FIG. 1 illustrates a particular arrangement of the user device 102, the social networking system 104, the third party system 112, and the network 108, various additional arrangements are possible. For example, the user device 102 may directly communicate with the social networking system 104 and/or the third party system 112, bypassing the network 108. Additional details relating to the network 108 are explained below with reference to FIG. 7.

The user 110 can use the user device 102 to, for example, access content from the social networking system 104 and/or third party system 112, communicate with the third party, and/or otherwise interact with components of the communication system 100. For example, the user 110 can use the user device 102 to receive messages from and/or send messages to the social networking system 104 and/or third party system 112. In some embodiments, the user 110 is an individual (i.e., human user of the social networking system 104). However, in alternative embodiments, the user 110 can be a business entity or other user. Although FIG. 1 illustrates only one user 110, it is understood that the communication system 100 can include a plurality of users, with each of the plurality of users interacting with the social networking system 104 and/or third party system 112 using corresponding user devices.

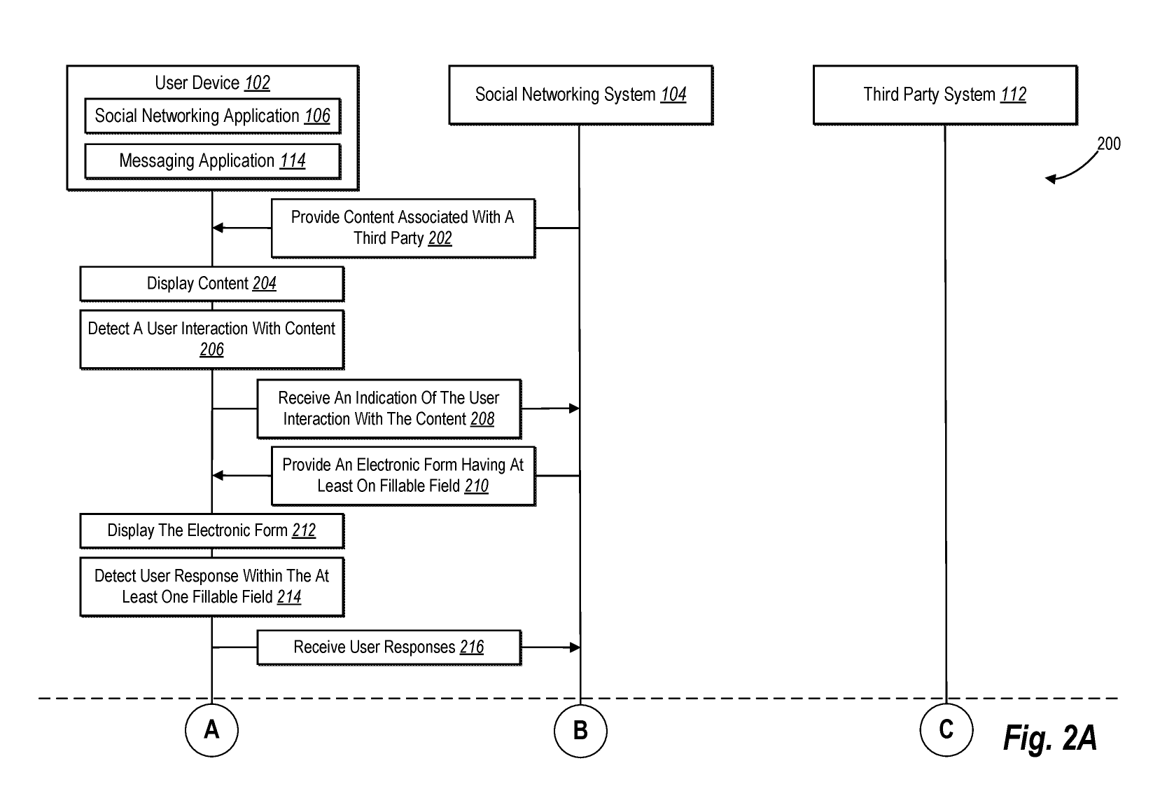

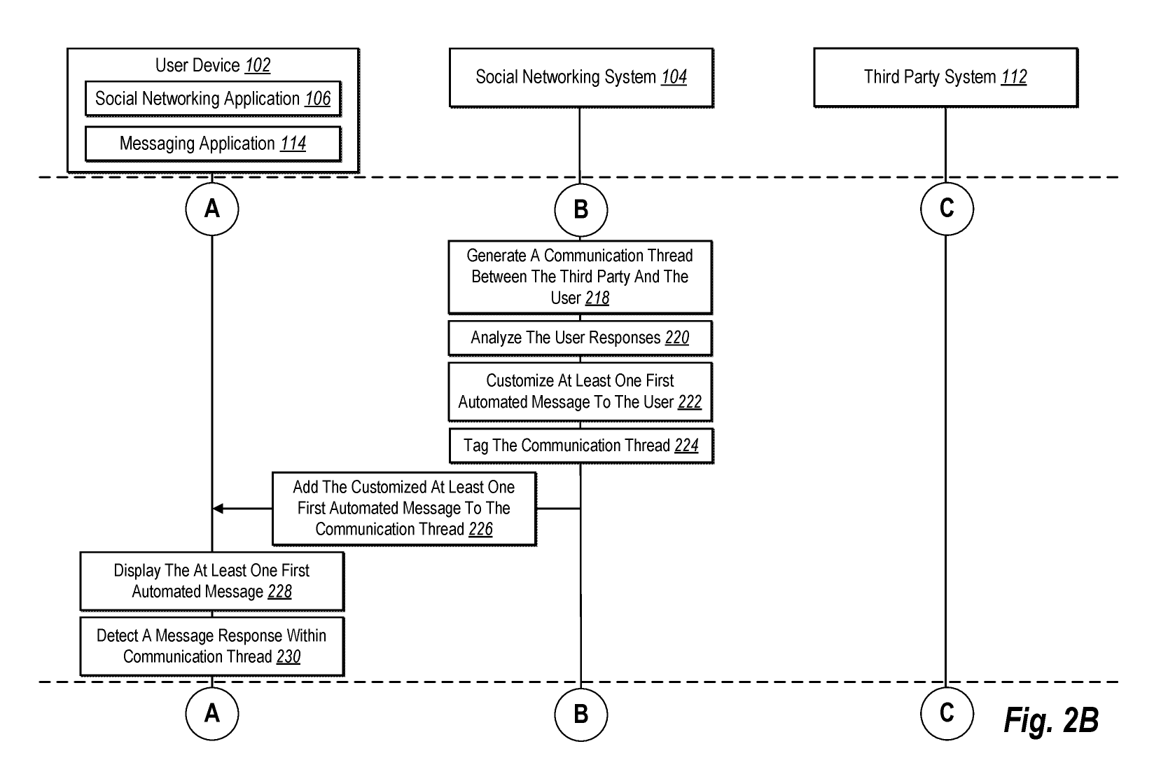

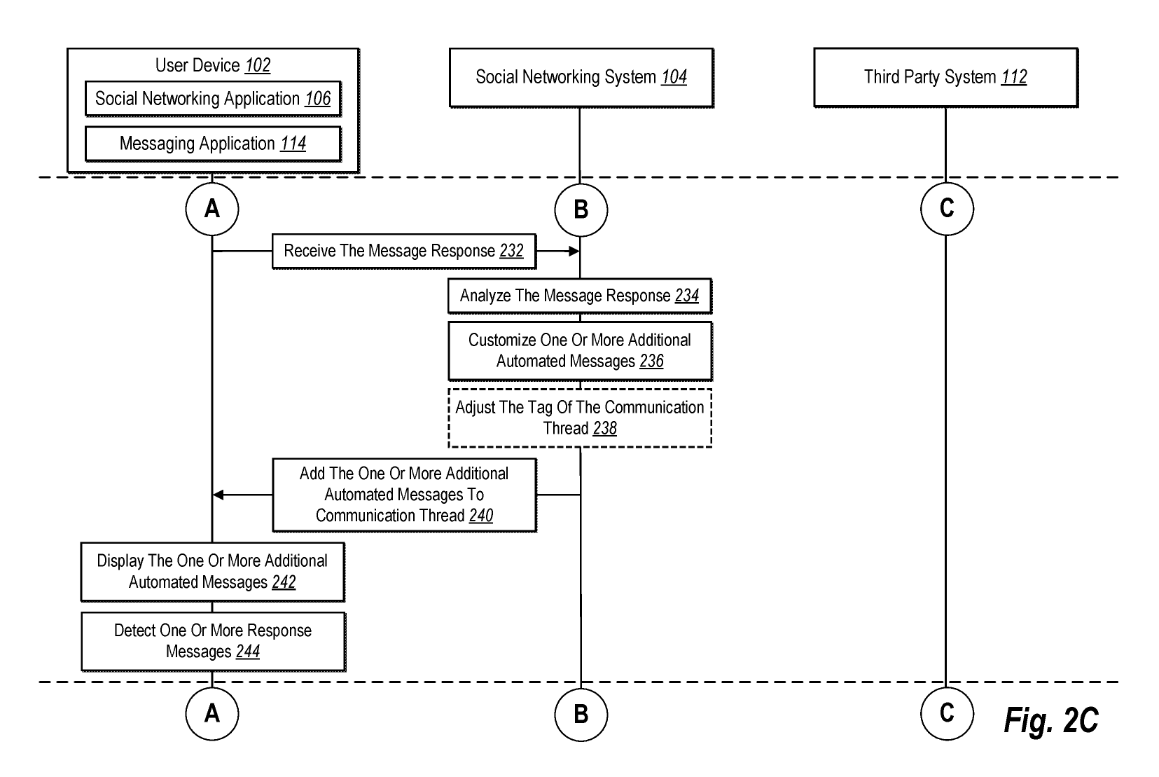

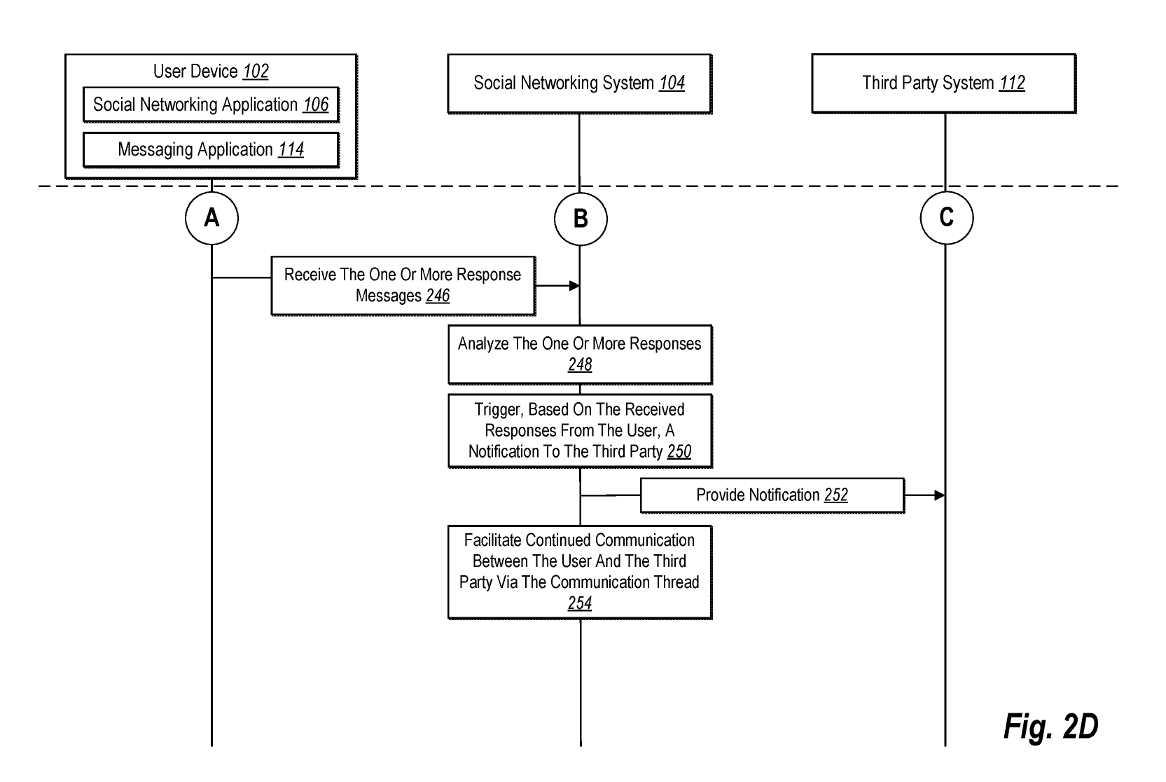

In some embodiments, the third party system 112 can include one or more server devices for providing content and/or services to customers, and/or for facilitating purchases from the third party. For example, the third party system 112 can include one or more servers that host a web page (e.g., an ecommerce web page) or other web-based application. In further embodiments, the third party system 112 can include one or more client computing devices for administering and/or managing services for the third party. For example, the third party system 112 can include a computing device used by a page administrator of the third party to manage a social networking page for the third party on the social networking system 104. Furthermore, the page administrator can utilize the third party system 112 to communicate with the user 110. In other words, the third party can use the third party system 112 to manage direct human interaction with the user 110 (e.g., to assign one or more administrators to a potential customer and/or manage and track communications with the potential customer). Furthermore, as will be discussed in greater detail below, upon a notification from the social networking system 104, the third party system 112 can communicate with the user device 102 via the social networking system 104 within a communication thread generated by the social networking system 104 for that purpose. The third party system 112 is described in greater detail below in regard to FIGS. 2A-2D.

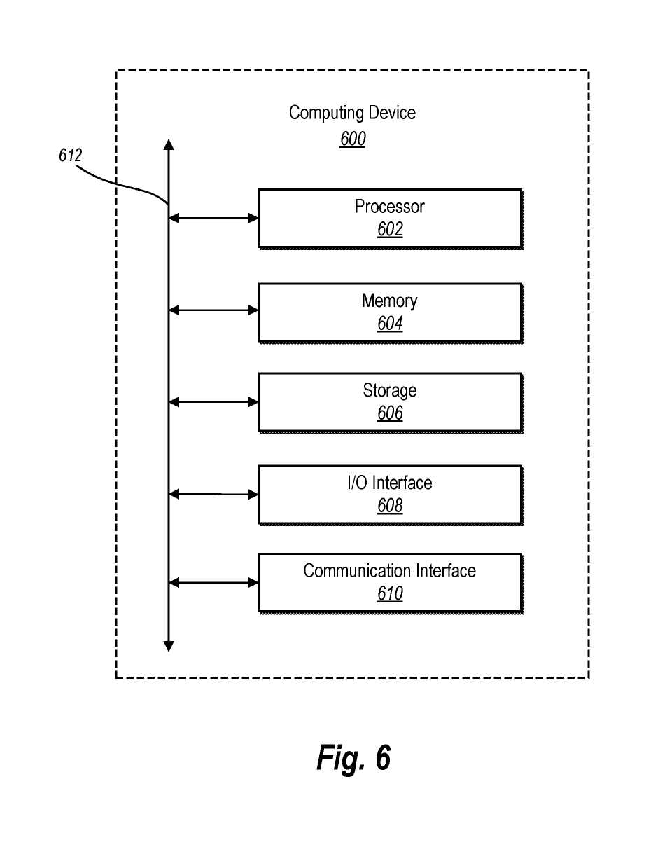

The user device 102 can be any one or more of various types of computing devices. For example, the user device 102 may include a mobile device such as a mobile telephone, a smartphone, a PDA, a tablet, or a laptop, or a non-mobile device such as a desktop, a server, or another type of computing device. Further, the user device 102 may run dedicated social networking applications (e.g., such as the social networking application 106) associated with the social networking system 104 to access and interact social networking content (e.g., posts, messages, profiles, etc.), and/or communicate with other users of the social networking system 104. Additional details with respect to the user device 102 are discussed below with respect to FIG. 6.

FIGS. 2A-2D illustrate a sequence-flow diagram 200 showing various steps of user device 102, social networking system 104, and third party system 112 in accordance with various embodiments of facilitating communications between a third party and users of the social networking system 104. The user device 102, the social networking system 104, and the third party system 112 shown in FIGS. 2A-2D may be example embodiments of the user device 102, the social networking system 104, and the third party system 112 described in regard to FIG. 1.

As shown in step 202 of FIG. 2A, the social networking system 104 provides content associated with a third party system 112 to the user 110 for display on a user device 102. In some embodiments, the social networking system 104 can provide the content within the social networking application 106 of the user device 102. For example, the social networking system 104 can provide the content item within the user's newsfeed, wall, timeline, communications threads, etc. of the social networking application 106. In particular, the content may include one or more of a post (e.g., a wall post), an event, an advertisement, a message, a notification, or any other suitable object for displaying within the social networking application 106, or any combination thereof.

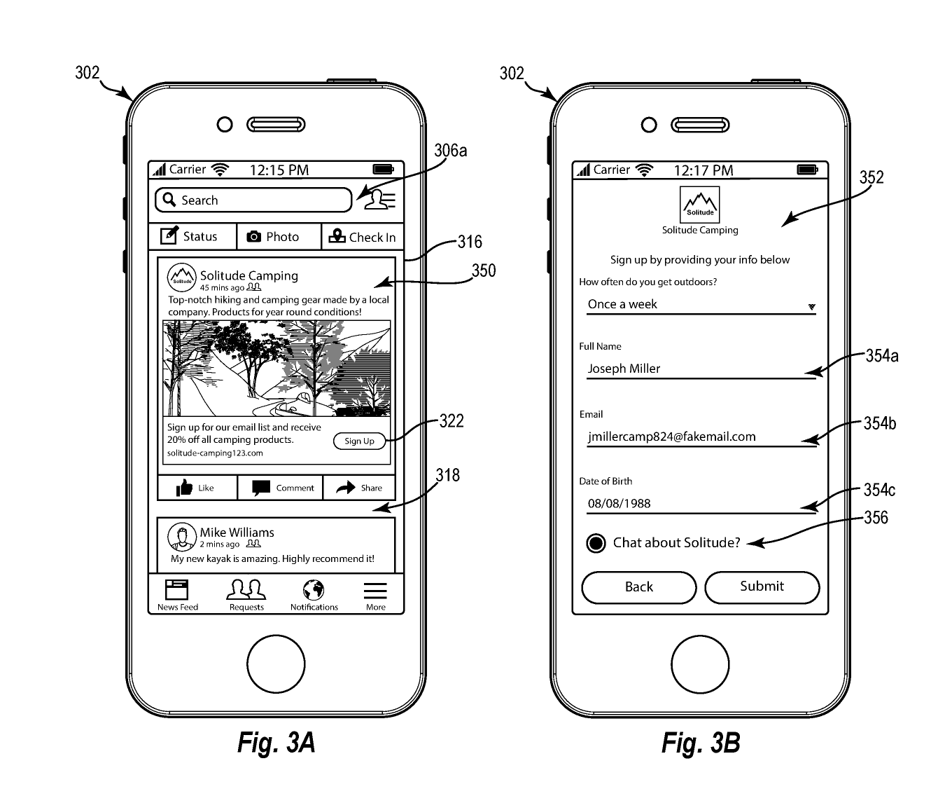

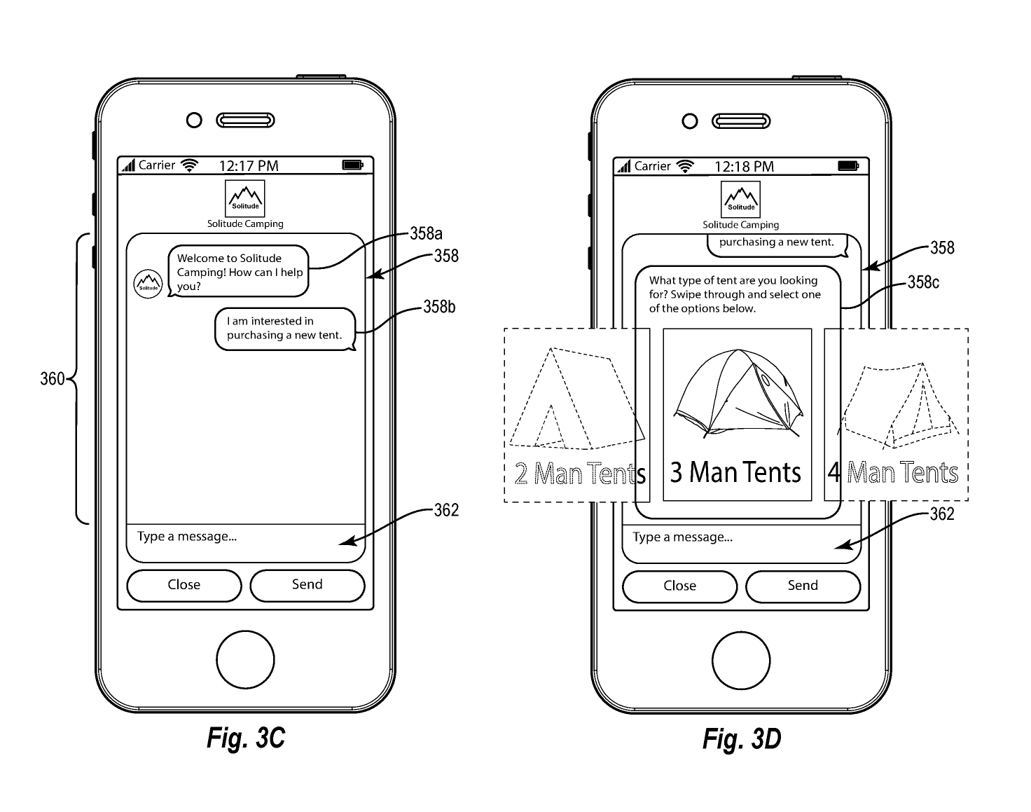

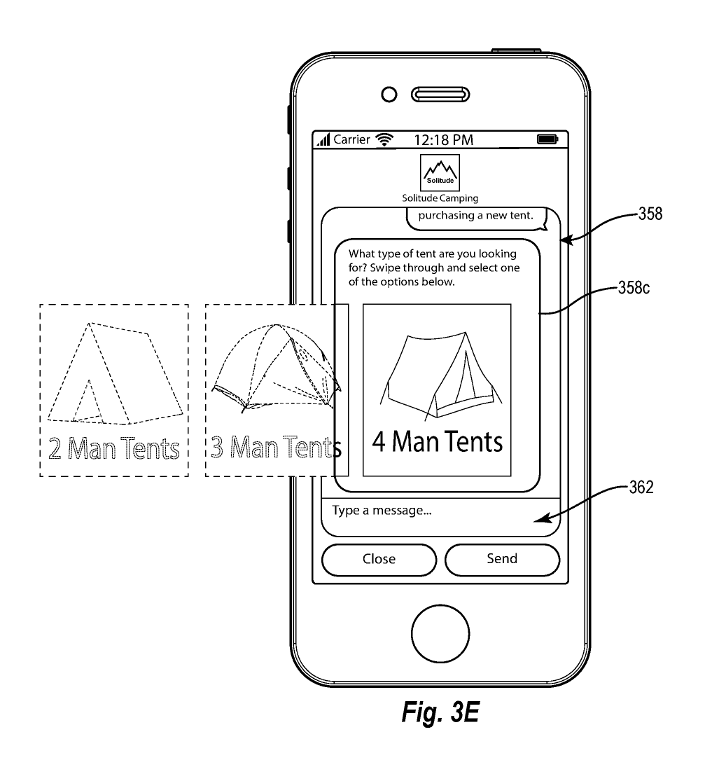

As noted above, the content can be associated with the third party system 112. In particular, the content can include an indication (e.g., text in regard to, images of, videos of, etc.) a commodity (e.g., a product, a service, an attraction, etc.) associated with third party system 112. Moreover, the content can include at least one selectable element that allows the user 110 to interact with (e.g., select, like, or share) the content accessed using the social networking application 106. The content is described in greater detail below in regard to FIGS. 3A-3E.

In response to receiving the content, the social networking application 106 and/or user device 102 displays the content within the social networking application 106, as shown in step 204. For example, as mentioned above, the social networking application 106 of the user device 102 can display the content item within one or more of a user's newsfeed, wall, timeline, communications threads, etc. of the social networking application 106. Additionally, in some embodiments, the social networking application 106 of the user device 102 can display the content item as a notification within the social networking application 106. Furthermore, the social networking application 106 of the user device 102 can display the content item via a graphical user interface (e.g., GUI) of the social networking application 106, as discussed in further detail in regard to FIGS. 3A-3E.

In addition to displaying the content within the social networking application 106, the social networking application 106 and/or user device 102 detects a user interaction with the content, as shown in step 206 of FIG. 2A. For example, the social networking application 106 of the user device 102 detects a user interaction with the at least one selectable element of the content. As used herein, the terms “user interaction” mean a single interaction, or combination of interactions, received from a user by way of one or more input devices (e.g., a touch screen display, a keyboard, a mouse, etc.) of the user device 102. Furthermore, the user interaction may include one or more of clicking, tapping, or otherwise selecting the at least one selectable element and/or any other portion of the content.

In response to the user device 102 detecting a user interaction with the content, the social networking system 104 receives an indication of the user interaction (e.g., that the user 110 of the user device 102 interacted with the content), as shown in step 208 of FIG. 2A. For example, the social networking system 104 can receive a communication (e.g., a data package) from the user device 102 and/or social networking application 106 of the user device 102 that indicates that the user 110 interacted with the content associated with the third party system 112. In other words, upon detecting a user interaction with the content, the user device 102 and/or social networking application 106 of the user device 102 can provide an indication of the user interaction to the social networking system 104. As an illustration, the user 110 can use the user device 102 to select an offer from the third party and the user device 102 can communicate an indication of that selection to the social networking system 104.

Upon receiving the indication of the user interaction with the content, the social networking system 104 can provide an electronic form to the user 110 (e.g., to the user device 102 for display to the user 110 via the social networking system 104), as shown in step 210 of FIG. 2A. In some embodiments, the electronic form can include one or more questions and one or more correlating fillable fields (e.g., an input areas) for receiving input (e.g., user responses) from a user. For ease of explanation, the electronic form will be referred to herein as having a plurality of fillable fields. In one or more embodiments, the questions can relate to one or more of the basic contact information of the user 110 (e.g., address, telephone number, email address, etc.), the general demographic of the user 110, the annual income of the user 110, a level of interest in the content associated with the third party system 112, and/or the best method to directly contact the user 110. In some instances, providing the electronic form to the user 110 can be optional. Specifically, providing the electronic form to the user 110 is not required in every embodiment. Rather, as is discussed below, the social networking system 104 can, in some embodiments, merely generate a communication thread with the user and can query the user for information without having the user 110 respond to the electronic form.

In one or more embodiments, the social networking system 104 can prefill (e.g., include an anticipated response within) one or more of the plurality of fillable fields of the electronic form based on information available to the social networking system 104 prior to providing the electronic form to the user 110. For example, in some embodiments, the social networking system 104 can prefill one or more of the plurality of fillable fields based on information available within a user profile of the user 110 within the social networking system 104. In additional embodiments, the social networking system 104 can prefill one or more of the plurality of fillable fields based on previous responses provided by the user 110 in regard to other aspects of the social networking system 104 (e.g., other content associated with an additional third party, communications within the social networking system 104, etc.).

In addition to including questions directed to the user 110 and the correlating plurality of fillable fields, the electronic form can include a selectable option (e.g., an optional request) to communicate with the third party (e.g., to be contacted by an administrator associated with the third party system 112 via the social networking system 104) via the messaging application 114 of the user device 102. For example, in some embodiments, the electronic form can include a markable area (e.g., a check box) where a user can indicate, by marking or by not marking, that the user would like to or would not like to communicate with the third party system 112 via the messaging application 114. In other embodiments, the electronic form can include a question asking permission to contact the user 110 via the messaging application 114 and a correlating fillable field where the user 110 can include a response “YES” or “NO.” Although particular examples are provided in regard to the user 110 selecting (e.g., requesting or giving permission) to communicate with the third party system 112, the present disclosure is not so limited, and the selectable option to communicate with third party system 112 can include any known methods for selecting an option within an electronic form.

In additional embodiments, the electronic form can enable the user 110 to select a preferred application to utilize when communicating with the third party system 112. In other words, the electronic form provides the user 110 with a choice of applications to use when communicating with the third party system 112. For example, the electronic form can enable the user 110 to select (e.g., choose) to communicate via the messaging system 103, a text messaging application, or any other messaging system/application.

In response to receiving the electronic form, the social networking application 106 and/or the user device 102 displays the electronic form within the social networking application 106, as shown in step 212 of FIG. 2A. For example, the social networking application 106 of the user device 102 can display the electronic form via one or more graphical user interfaces associated with the social networking application 106, and/or one or more web pages of the social networking system 104 or third party system 112. In any event, the user device 102 displays the electronic form such that the user 110 can input one or more responses within the plurality of fillable fields of the electronic form.

In addition to displaying the content, the user device 102 and/or the social networking application 106 detects user inputs within the electronic form, as shown in step 214 of FIG. 2A. In particular, the social networking application 106 of the user device 102 detects the user 110 providing one or more user responses within the plurality of fillable fields of the electronic form. For example, the social networking application 106 detects the user 110 providing textual responses within the plurality of fillable fields of the electronic form. Furthermore, the social networking application 106 detects a selection of the selectable option to communicate with the third party system 112 via the messaging application 114. In some instances, the social networking application 106 may not detect the user 110 providing user responses within every fillable field of the plurality of fillable fields of the electronic form. In other words, the user 110 may not provide a response for one or more of the questions of the electronic form. Furthermore, the social networking application 106 can generate a data package representing the detected user responses, indicating questions for which user responses were not detected, an indicating whether the user 110 would like to communicate with the third party system 112 via the messaging application 114. Upon generating the data package, the social networking application 106 can provide the data package to the social networking system 104.

As shown in step 216 of FIG. 2A, the social networking system 104 can receive the user responses from the user device 102. Furthermore, in some embodiments, as mentioned above, the social networking system 104 may not receive responses for every fillable field of the plurality of fillable fields of the electronic form. In other words, the user may not answer every question of the electronic form. For example, the social networking system 104 may receive a user response for at least one fillable field of the plurality of fillable fields of the electronic form and may not receive a user response for at least one other fillable field of the plurality of fillable fields. Furthermore, the social networking system 104 can receive the indication that the user 110 would like to communicate with the administrator via the messaging application 114 (e.g., that the user selected the selectable option of the electronic form).

In response to receiving the user responses to the electronic form and the request to communicate with the third party system 112 from the user 110, the social networking system 104 generates (e.g., creates, initiates) a communication thread between the user 110 and the third party system 112. Furthermore, the social networking system 104 and/or the social networking application 106 can provide a communication graphical user interface (“GUI”) for facilitating communication between the user 110 and the third party system 112. In particular, the social networking system 104 generates a communication thread and associates a unique thread identifier (hereinafter “thread ID”) with the communication thread. As used herein, the term “communication thread” may refer to a two-way communication connection between the user 110 and the third party system 112. Furthermore, “communication thread” refers to a series of communications between the user 110 and the third party system 112 (e.g., an administrator associated with the third party system 112) wherein each communication (e.g., message) of the user 110 and the third party is added to the communication thread, associated with the thread ID, and is viewable by both the user 110 and the third party system 112. In some embodiments, the communication thread enables textual communication (e.g., text messages). In additional embodiments, the communication thread enables audio and/or visual (e.g., video) communication. In one or more embodiments, the social networking system 104 sends a request to one or more of the messaging application 114 and the messaging system 103 to generate the thread ID. Furthermore, in some instances, the messaging application 114 and/or the messaging system 103 can determine that a communication thread already exists between the user 110 (via a user ID) and the third party system (via a page ID) and can provide the associated thread ID to the social networking system 104.

Furthermore, in some embodiments, the social networking system 104 can generate the communication thread according to a preferred application (e.g., messaging application). For example, if the user 110 selected a preferred application within the electronic form, as described above in regard to step 214 of FIG. 2A, the social networking system 104 can generate the communication thread within the preferred application. On the other hand, if the user 110 did not select a preferred messaging application 114, the social networking system 104 can generate the communication thread within a default application (e.g., the messaging application 114 and/or the messaging system 103). For example, in such embodiments, the social networking system 104 can initiate the communication thread within a messaging application associated with the social networking application 106 of the social networking system 104.

In addition to generating the communication thread and the communication GUI, the social networking system 104 can analyze the user responses to determine meanings of the user responses, as shown in step 220 of FIG. 2B. In particular, the social networking system 104 can include a natural language processing (“NLP”) system for processing and deriving meaning from human and/or natural language input (e.g., the user responses within the electronic form). For example, the social networking system 104 can include any NLP system known in the art. Accordingly, the social networking system 104 can analyze the user responses via the NLP system to determine and derive meanings of the user responses.

As a few non-limiting examples, in some embodiments, the social networking system 104 can analyze the user responses to determine a level of interest of the user 110 in the content associated with the third party system 112. For example, the social networking system 104 can utilize the NLP system to determine meanings of the user responses received via the electronic form, and from the meanings of the user responses, the social networking system 104 can determine a level of interest of the user 110 in the content associated with the third party system 112. In additional embodiments, via the above-described analysis, the social networking system 104 can determine that the user responses indicate that the user 110 is prepared to make a purchase in relation to the content. In one or more embodiments, the social networking system 104 can analyze the user responses to determine a demographic (e.g., age, sex, education level, income level, marital status, occupation, etc.) of the user 110.

In yet further embodiments, the social networking system 104 can analyze the user responses to determine whether the user 110 is prepared (e.g., ready) to directly communicate with the third party. For example, based on the user responses received from the user 110, the social networking system 104 can determine that the user 110 is ready to discuss the content directly with a representative of the third party. As an additional example, based on the user responses received from the user 110, the social networking system 104 can determine that the user 110 needs assistance (e.g., customer service) from the third party.

Additionally, the social networking system 104 can customize at least one first automated message to provide to the user 110 based on the user responses received via the electronic form, as shown in step 222 of FIG. 2B. As used herein, the term “customize” when used in regard to a message can refer to the social networking system 104 adjusting a predetermined message (e.g., changing the language of the message to appropriately correspond to the user responses). Furthermore, the term “customize” can refer to the social networking system 104 selecting an automated message from a plurality of automated messages that best correlates to the user responses. Additionally, the term “customize” can refer to selecting a series of automated messages from a plurality of series of automated messages that best responds to the user responses. Moreover, the term “customize” can refer to the social networking system 104 generating at least a portion of an automated message to address the user responses. In some embodiments, the social networking system 104 can customize the at least one first automated message to concern questions included in the electronic form. In one or more embodiments, the social networking system 104 can customize the at least one first automated message to determine (e.g., gage, measure, ask about, concern, etc.) the user's interest in the content associated with the third party system 112. Each of the foregoing will be described in greater detail below.

As noted above, the social networking system 104 can customize the at least one first automated message to appertain to questions included in the electronic form. Specifically, in some embodiments, the social networking system 104 can customize the at least one first automated message to appertain to questions to which user responses were not received (e.g., respective fillable fields that did not receive user responses) and to questions to which user responses were received (e.g., respective fillable fields that received responses). For example, when a user response is not received within one or more fillable fields of the plurality of fillable fields of the electronic form, the social networking system 104 can customize the at least one first automated message to appertain to the one or more questions (e.g., the fillable fields) for which user responses were not received. Particularly, in some embodiments, the social networking system 104 can include a message database having stored thereon a plurality of automated messages related to the questions included in the electronic form. Accordingly, if a user response is not received for a particular question included in the electronic form, the social networking system 104 can query the message database, determine at least one first automated message appertaining to the particular question, and customize, based on other received user responses, the determined automated message to request further information in regard to the particular question.

On the other hand, when a response is received within one or more fillable fields of the electronic form, the social networking system 104 can customize the at least one first automated message to appertain to one or more of the questions (e.g., the fillable fields) for which user responses were received. For example, the message database of the social networking system 104 can include one or more automated messages that appertain to each question (e.g., one or more automated messages that expound on the original question and/or request additional information about the question) of the electronic form. Accordingly, if a response is received for a particular question included in the electronic form, the social networking system 104 can query the message database, determine an automated message in regard to the particular question, and customize, based on the received response to the question, the determined automated message to request further information in regard to and/or expound on a particular question. For example, an original question on the electronic form can ask “Have you ever owned a product associated with [the content], and if so, which?” and if the response received from the user 110 is “YES, [Product 1]”, the social networking system 104 can query the message database, determine an automated message that concerns the particular question, and customize, based on previously received response to the question, the automated message to recite “On a scale of 1 to 10, how would you rate your experience with [Product 1]?”

As mentioned briefly above, in some embodiments, the social networking system 104 can customize, based on the user responses provided in the electronic form, the at least one first automated message to determine (e.g., gage, ascertain, etc.) a level of interest of the user 110 in the content associated with the third party system 112. In particular, based on the meanings of the user responses derived (e.g., the analysis performed in regard to step 220 of FIG. 2B) by the NLP system, the social networking system 104 can determine an approximate level of interest of the user 110 in the content associated with the third party system 112, and based on the approximate interest, the social networking system 104 can customize that least one first automated message to further determine (e.g., ascertain) a level of interest of the user 110. For example, if the approximate level of interest is relatively high, the social networking system 104 can provide and/or customize automated messages appertaining to relatively high levels of interest. In other words, the social networking system 104 can avoid providing and/or customizing automated messages appertaining to relatively low levels of interest (e.g., the social networking system 104 can skip preliminary questions). On the other hand, if the approximate level of interest is relatively low, the social networking system 104 can provide and/or customize automated messages appertaining to relatively low levels of interest.

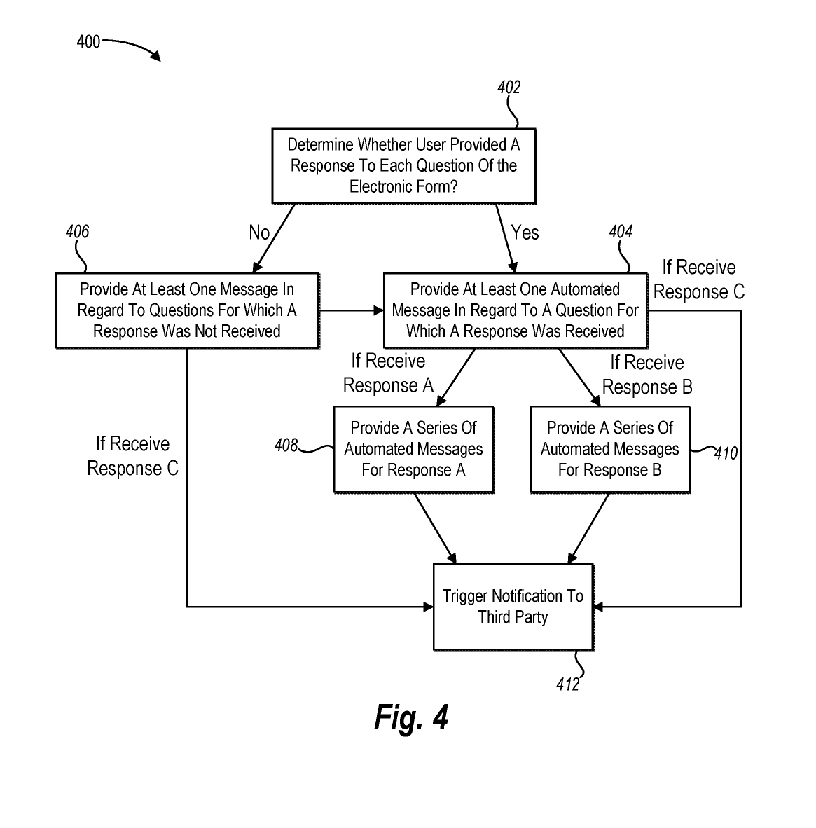

As discussed above, in some embodiments, based on the user responses received via the electronic form, the social networking system 104 can select one or more particular series of automated messages to customize and provide to the user 110. For example, based on the user responses received via the electronic form, the social networking system 104 can query the message database to determine one or more series of automated messages appertaining to the user responses received via the electronic form and can customize those one or more series of automated messages based on the user response received via the electronic form. A non-limiting example of the social networking system 104 customizing at least one automated message is described in regard to FIG. 4.

Furthermore, although the at least one automated message is described above as a textual message, the disclosure is not so limited. For example, that at least one automated message can include elements enabling action by the user 110. Specifically, the at least one automated message can include multi-select options to select products and/or variations of products, payment options, video content with details on the product and/or related products, audio content, etc. (see, e.g., FIGS. 3D-3E and description below).

In addition to customizing at least one first automated message to provide to the user 110, the social networking system 104 can optionally generate a tag and can associate the tag with the communication thread between the third party system 112 and the user 110, as shown in step 224 of FIG. 2B. In additional embodiments, the messaging application 114 and/or the messaging system 103 can generate a tag and can associate the tag with the communication thread between the third party system 112 and the user 110. As used herein, the term “tag” and any derivative terms refer to associating identifying (e.g., describing) data with the communication thread. Specifically, a tag can indicate aspects (e.g., attributes) of the communication thread. For example, the tags can be utilized to notify the third party system 112 (e.g., the administrator system) as to the particular situation or status of the communication thread. For instance, the tags can be displayed within an administrator page within the social networking system 104 and associated with the third party system 112. Additionally, the tags can be displayed within a customer relationship management (“CRM”) system of the third party system 112. Furthermore, the tags can be displayed within the communication thread and may be viewable only by the third party system 112 and/or the social networking system 104. For instance, as will be described in further detail below, the tags can be displayed within and/or used to organize/sort inboxes (e.g., messaging inboxes) of the administrator page and/or CRM system of the third party system 112.

In some embodiments, the social networking system 104 can tag the communication thread based on the content with which the user 110 interacted (e.g., the content associated with the third party system 112). In additional embodiments, the social networking system 104 can tag the communication thread based on the analysis performed on the user responses from the user 110 (e.g., the analysis described above in regard to step 220 of FIG. 2A). The foregoing examples will be discussed in further detail below.

As mentioned briefly above, the social networking system 104 can tag the communication thread based on the content with which the user 110 interacted. For example, the social networking system 104 tags the communication thread with a content ID number (e.g., an advertisement ID number) associated with the particular content with which the user 110 interacted. Furthermore, the social networking system 104 can tag the communication thread with a page ID number (e.g., a page ID number of a page within the social networking system 104 associated with the third party).

Furthermore, as noted above, the social networking system 104 can tag the communication thread based on the analysis performed on the responses from the user 110. In some embodiments, the social networking system 104 can tag the communication thread based on a level of interest of the user 110 in the content determined via the analysis. In additional embodiments, the social networking system 104 can tag the communication thread as requiring attention (e.g., assistance) from the third party system 112 as determined via the analysis. Each of the foregoing examples is described in greater detail below.

As mentioned above, the social networking system 104 can tag the communication thread based on the level of interest of the user 110 in regard to the content. In particular, based on the analysis performed on the user responses provided in the electronic form described above in regard to step 222 of FIG. 2B, the social networking system 104 can tag the communication thread to indicate the level of interest. For example, if the determined level of interest is relatively high, the social networking system 104 can tag the communication thread as having high interest (e.g., with a tag such as “High Interest”). On the other hand, if the determined level of interest is relatively low, the social networking system 104 can tag the communication thread as having a low interest. Furthermore, if the determined level of interest indicates that the user 110 is prepared (e.g., ready) to make a purchase in relation to the content, the social networking system 104 can tag the communication thread as being ready to make a purchase. Moreover, based on the determined level of interest, the social networking system 104 can tag the communication thread as a high priority thread or as a low priority thread. As will be discussed in greater detail below, the social networking system 104 can facilitate communication between the user 110 and the third party system 112, and the third party system 112 can use the tags to categorize the communication threads (e.g., to prioritize the communication threads in order to assign available resources).

As mentioned briefly above, based by the analysis performed by the social networking system 104, the social networking system 104 can tag the communication thread as requiring attention (e.g., assistance) from the third party system 112. In other words, the notification can include an indication that the user 110 requires customer service. For example, if the social networking system 104 cannot determine the meaning of the received user responses (e.g., the user responses are unclear), the social networking system 104 can tag the communication thread as requiring attention from the third party system 112. As another non-limiting example, if the social networking system 104 determines via the analysis that the user 110 is repeatedly asking for an administrator (e.g., a representative), the social networking system 104 can tag the communication thread as requiring attention (e.g., assistance) from the third party.

Although specific examples of tagging the communication thread are described herein, the present disclosure is not so limited, and the social networking system 104 can tag the communication to indicate any aspect of the communication thread (e.g., can tag the communication thread to appertain to any received user response). For example, the social networking system 104 can tag the communication thread to indicate any particular aspect of the demographic of the user 110.

In addition to tagging the communication thread, the social networking system 104 can add the customized at least one first automated message to the communication thread for display to the user 110, as shown in step 226 of FIG. 2B. For example, the social networking system 104 can assign the thread ID to (e.g., associate the communication thread ID with) the customized automated message such that the customized automated message is viewable by the user 110 within the communication GUI. Adding the customized at least one first automated message to the communication thread is described in further detail below in regard to FIGS. 3A-3E.

In response to the social networking system 104 adding the customized at least one first automated message to the communication thread, the social networking application 106 and/or the user device 102 can display the customized at least one first automated message within the messaging application 114 of the user device 102, as shown in step 228 of FIG. 2B. As noted above, in some embodiments, the messaging application 114 is associated with the social networking application 106, and in such embodiments, the social networking application 106 can display the customized at least one first automated message via the communication GUI within the social networking application 106 (e.g., within a messenger feature of the social networking application 106). In additional embodiments, the messaging application 114 can display the customized at least one first automated message within a messaging window distinct from the social networking application 106. In yet further embodiments, the messaging application 114 can direct the user 110 to another third party messaging application and can cause the customized at least one first automated message to be displayed within the third party messaging application.

Additionally, the social networking application 106 and/or the user device 102 can detect a message response to the customized at least one first automated message from the user 110 within the communication thread, as shown in step 230 of FIG. 2B. In particular, the social networking application 106 and/or the user device 102 can detect a message response from the user 110 within the messaging application 114 (e.g., a messaging application) of the user device 102. For example, the social networking application 106 can detect a text message input by the user 110 within the messaging application 114. Furthermore, the social networking application 106 can generate a data package representing the message response and can provide the data package to the social networking system 104.

The social networking system 104 can receive the message response from the user device 102, as shown in step 232 of FIG. 2C. For example, the social networking system 104 can receive the data representing the message response through the network 108 and/or from the messaging application 114.

In response to receiving the message response to the customized at least one first automated message, the social networking system 104 can analyze the message response, as shown in step 234 of FIG. 2C. For example, as mentioned above, the social networking system 104 can include an NLP system, such as any NLP system known in the art, and the social networking system 104 can utilize the NLP system to determine a meaning of the message response to the customized at least one first automated message. In additional embodiments, the social networking system 104 can determine an intent of the message response (i.e., an intent of the user) utilizing machine learning techniques (e.g., a neural network). In some embodiments, the social networking system 104 can determine whether a sufficient response to the customized at least one first automated message (e.g., a response addressing the at least one first automated message) has been received. Furthermore, similar to the analysis described above in regard to step 220 of FIG. 2A, by determining a meaning of the message response to the customized at least one first automated message, the social networking system 104 can determine a level of interest of the user 110 in the content associated with the third party system 112 or a demographic of the user 110. Additionally, by determining a meaning of the message response to the customized at least one first automated message, the social networking system 104 can determine any questions that may be included in the message response (e.g., questions presented by the user 110). Moreover, the social networking system 104 can analyze the message response to the customized at least one first automated message according to any of the manners described above in regard to step 220 of FIG. 2B.

In addition to analyzing the message response to the customized at least one first automated message, the social networking system 104 can customize one or more additional automated messages to the user 110 based on the message response to the customized at least one first automated message, as shown in step 236 of FIG. 2C. In some embodiments, the social networking system 104 can customize one or more additional automated messages to the user 110 to respond and/or address the message response to the customized at least one first automated message. For example, the social networking system 104 can customize one or more additional automated messages based on the determined intent of the message response (i.e., user). In additional embodiments, as noted above, based on the message response to the customized at least one first automated message, the social networking system 104 can determine that a sufficient response has been received in regard to a question appertaining to a first topic (e.g., a question included in the electronic form and/or the customized at least one first automated message), and the social networking system 104 can customize an additional automated message to appertain to another topic. In one or more embodiments, the social networking system 104 can customize one or more additional automated messages according to any of the manners described above in regard to step 222 of FIG. 2B.

Furthermore, in some embodiments, the social networking system 104 can at least partially generate the one or more additional automated messages to customize the one or more additional automated messages. For example, the social networking system 104 can include a natural language generation (“NLG”) system for generating and/or customizing at least a portion of the one or more additional automated messages to respond to the message response to the customized at least one first automated message. In other words, the social networking system 104 can generate natural language messages from a machine representation system such as a knowledge base and/or a logical form.

Additionally, in one or more embodiments, the social networking system 104 can customize a series (e.g., a set of sequential messages) of additional automated messages at least partially based on the message response to the customized at least one first automated message and/or the user responses received vice the electronic form (referred to herein collectively as “previous responses from the user”). In such embodiments, based on the previous responses from the user 110, the social networking system 104 determines a series of additional automated messages that is pertinent to (e.g., concerns) one or more of the previous responses from the user 110. For example, the social networking system 104 can query the message database and can determine a series of additional automated messages that is most pertinent to one or more of the previous responses from the user 110. In particular, after determining the meaning of the previous responses from the user 110, as discussed above, the social networking system 104 can query the message database to determine a series of additional automated messages that is pertinent to (e.g., responds to, relates to) one or more of the previous responses from the user 110.

Beyond customizing the one or more additional automated messages, the social networking system 104 can optionally tag and/or adjust a tag of the communication thread based on the message response to the customized at least one first automated message, as shown in step 238 of FIG. 2C. For example, the social networking system 104 can tag the communication thread in any of the manners described above in regard to step 224 of FIG. 2B. Furthermore, if the communication thread has already been tagged, the social networking system 104 can adjust (e.g., change) the tag and/or add an additional tag to the communication thread based on the message response to the customized at least one first automated message. For example, if based on the message response to the customized at least one first automated message, the social networking system 104 determines (e.g., determines through the analysis described above in regard to step 234 of FIG. 2C) that a level of interest of the user 110 has changed and/or that the user 110 is interested in content different than the content with which the user 110 interacted, the social networking system 104 can adjust (e.g., change) the tag and/or add an additional tag to the communication thread to indicate the change in interests. Furthermore, the social networking system 104 can tag the communication thread according to anything included in the message response to the customized at least one first automated message.

Furthermore, upon customizing the one or more additional automated messages, the social networking system 104 adds the one or more additional automated messages to the communication thread for display to the user 110 of the user device 102, as shown in step 240 of FIG. 2C. For example, the social networking system 104 can assign the communication thread ID to (e.g., associate the communication thread ID with) the customized one or more additional automated messages such that the customized one or more additional automated messages are viewable to the user 110 within the messaging application 114. Adding the customized one or more additional automated messages to the communication thread is described in further detail below in regard to FIGS. 3A-3E.

In response to the social networking system 104 adding the customized one or more additional automated messages to the communication thread, the social networking application 106 of the user device 102 can display the customized one or more additional automated messages to the user 110 of the user device 102, as shown in step 242 of FIG. 2B. For example, the social networking application 106 can display the customized one or more additional automated messages within the messaging application 114 of the user device 102. As noted above, in some embodiments, the messaging application 114 is associated with the social networking application 106, and in such embodiments, the social networking application 106 can display the customized one or more additional automated messages via a communication GUI within the social networking application 106 (e.g., within a messenger of the social networking application 106). In additional embodiments, the messaging application 114 can display the customized one or more additional automated messages within a messaging window distinct from the social networking application 106. In yet further embodiments, the messaging application 114 can direct the user 110 to another third party messaging application and can cause the customized one or more additional automated messages to be displayed within the third party messaging application.

Additionally, the social networking application 106 and/or the user device 102 can detect one or more additional message responses to the customized one or more additional automated messages from the user 110 within the communication thread, as shown in step 244 of FIG. 2C. In particular, the social networking application 106 and/or the user device 102 can detect one or more additional message responses from the user 110 within the messaging application 114 (e.g., a messaging application) of the user device 102. For example, the social networking application 106 can detect one or more text-based messages input by the user 110 within the messaging application 114. Furthermore, the social networking application 106 can generate a data package representing the one or more additional message responses and can provide the data package to the social networking system 104.

The social networking system 104 can receive the one or more additional message responses from the user device 102, as shown in step 246 of FIG. 2D. For example, the social networking system 104 can receive the data representing the one or more additional message responses through the network 108 and/or from the messaging application 114.

In response to receiving the one or more additional message responses to the customized one or more additional automated messages, the social networking system 104 can analyze the one or more additional message responses, as shown in step 248 of FIG. 2D. As mentioned above, the social networking system 104 can include a NLP system and the social networking system 104 can utilize the NLP system to determine meanings of the one or more additional message responses to the customized one or more additional automated messages. Furthermore, similar to the analysis described above in regard to step 220 of FIG. 2B, by determining the meaning of the one or more additional message responses to customized one or more additional automated messages, the social networking system 104 can determine a level of interest of the user 110 in the content associated with the third party system 112 and/or a demographic of the user 110. Additionally, by determining the meaning of the one or more additional message responses to the customized one or more additional automated messages, the social networking system 104 can determine any questions that may be included in the one or more additional message responses (e.g., questions presented by the user 110).

In some embodiments, the social networking system 104 can repeat steps 234-248 of FIGS. 2C and 2D as described above as many times as is deemed necessary by the social networking system 104 or as necessary to receive sufficient responses to messages, questions, etc. For example, in some embodiments, the social networking system 104 can customize a first additional automated message to the user 110, add the customized first additional automated message to the communication thread, receive a first additional response to the customized first additional automated message, and customize a second additional automated message to the user 110 based on the first additional response to the customized first additional automated message. Furthermore, the social networking system 104 can repeat the above-described procedure with a third additional automated message, a fourth additional automated message, a fifth additional automated message, etc. In other words, the social networking system 104 can customize the additional automated messages to the user 110 on a message by message basis with each subsequent message being customized based on any of the previous responses received from the user 110.

In addition to customizing one or more additional automated messages, based on one or more of the user 110 responses to the electronic form, the message response to the customized at least one first automated message, and/or the one or more additional message responses to the one or more additional messages responses (referred to hereinafter collectively as “received responses from the user”), the social networking system 104 can trigger a notification to the third party system 112, as shown in step 250 of FIG. 2D. In some embodiments, the social networking system 104 can trigger (e.g., generate) a notification to the administrator system associated with the third party system 112. In one or more embodiments, the notification may include an indication that the user 110 is in a condition (e.g., is ready) to communicate with the third party directly.

The social networking system 104 can determine to trigger the notification to the third party system 112 in response to an occurrence of a threshold event. In some embodiments, the threshold event includes the social networking system 104 receiving a predetermined number of responses from the user 110 (e.g., received responses from the user 110). In additional embodiments, the threshold event includes the social networking system 104 receiving a predetermined response from the user 110 (e.g., a predetermined response within the received responses from the user 110). In one or more embodiments, the threshold event includes the social networking system 104 providing a predetermined set of customizable automated messages to the user 110. Each of the foregoing examples is discussed in greater detail below.

As mentioned briefly above, the threshold event can include the social networking system 104 receiving a predetermined number of responses from the user 110 (e.g., a predetermined number of responses including any of the received responses from the user 110). In other words, the threshold event can include the social networking system 104 receiving, for example, 2, 5, 10, or more responses from the user 110. Put another way, after the social networking system 104 receives the predetermined number of responses from the user 110, the social networking system 104 triggers the notification to the third party system 112 that the user 110 is ready to communicate with the third party directly (e.g., for direct human interaction).

Also, as noted above, the threshold event can include the social networking system 104 receiving a predetermined response from the user 110 (e.g., a predetermined response within the received responses from the user 110). In some embodiments, the threshold event can include the social networking system 104 receiving a positive response from the user 110 in regard to making a purchase. In additional embodiments, the threshold event can include the social networking system 104 receiving an affirmative response from the user 110 that the user 110 is ready to communicate directly with the third party. In additional embodiments, the threshold event can include the social networking system 104 receiving a response that the user 110 requires customer service. Regardless, upon receiving the predetermined response, the social networking system 104 triggers the notification to the third party system 112 that the user 110 is ready to communicate with the third party directly.

Furthermore, as discussed above, the threshold event can include the social networking system 104 providing a predetermined set of customizable automated messages to the user 110. In other words, the threshold event occurs when the social networking system 104 has provided the predetermined set of customizable automated messages to the user 110. In particular, as discussed briefly above in regard to step 236 of FIG. 2C, the social networking system 104 can have a predetermined set (e.g., series) of customizable automated messages to provide to the user 110 through the methods described above in regard to steps 234-248 of FIGS. 2A-2D. Furthermore, upon providing the predetermined set of customizable automated messages to the user 110, the social networking system 104 triggers the notification to the third party system 112 that the user 110 is ready to communicate with the third party directly.

In some embodiments, the notification can include one or more of a message, an email, an event, a pop-up, an alert, a task notification, an addition to a task list, an audio notification, etc. Additionally, the notification can include an indication of the tags associated with the communication thread. In other words, the notification can include within, for example, the content of the notification, the tags associated with the communication thread to indicate a status of the communication and/or the necessary attention required from the third party. The notification can further include content from the communication thread itself (e.g., messages from the user and/or a summary of the information gathered by the social networking system 104). Furthermore, in one or more embodiments, the notification can include a selectable element to initiate direct communication with the user 110.

Upon triggering the notification to the third party system 112, the social networking system 104 can provide the notification to the third party system 112, as shown in step 252 of FIG. 2D. In some embodiments, the social networking system 104 can provide the notification to the third party system 112 via the network 108 using any suitable communication protocols. For example, the social networking system 104 can add the notification to an administrator page/system associated with the third party's page on the social networking system. In other embodiments, as noted above, the social networking system 104 can integrate with a CRM system of the third party system 112 and provide the notification via the CRM system and/or add one or more tasks associated with the user 110 to be assigned to administrators of the third party system 112. Furthermore, the social networking system 104 can add the communication thread, the notification, and any associated tags to a particular inbox (e.g., an inbox of the administrator page/system and/or an inbox of the CRM system of the third party system 112) based on tags associated with the communication thread. For example, the social networking system 104 can add the communication thread and the notification to an inbox for a particular customer service representative of the third party system 112 that is tasked with a particular tag (e.g., a tag indicating a product category, a tag indicating a category of required assistance, a tag indicating a level of interest, etc.) associated with the communication thread. For instance, if the communication thread includes a tag indicating a High Interest level, as described above in regard to step 224 of FIG. 2B, the social networking system 104 can add the communication thread and notification to an inbox of a customer service representative of the third party system 112 tasked with communicating with users having high interest levels.

Furthermore, upon notifying (e.g., providing the notification to) the third party system 112, the social networking system 104 can facilitate continued communication between the user 110 and the third party system 112 via the communication thread, as shown in step 254 of FIG. 2D. In some embodiments, the social networking system 104 can facilitate continued communication between the user 110 and the third party system 112 via the messaging application 114 (e.g., messaging application). In one or more embodiments, the social networking system 104 can facilitate continued communication between the user 110 and the third party system 112 via the social networking system 104 (e.g., via the social networking application 106). Furthermore, the social networking system 104 can facilitate continued communication between the user 110 and the third party system 112 via any of the communication forms described above in regard to step 218 of FIG. 2B.

In further embodiments, a messaging system (e.g., messaging system 103) performs one or more of the steps illustrated as being performed by the social networking system 104 in FIGS. 2A-2D. For example, the messaging system 103 can perform one or more of steps 218, 220, 222, 224, 226, 232, 234, 236, 238, 240, 246, 248, 250, 252, or 254.

FIGS. 3A-3E illustrate a flow of user interfaces including features of the communication system 100 according to an embodiment of the present disclosure. As will be described in more detail below, the components of the communication system 100 as described in regard to FIGS. 1-2D can provide, alone and/or in combination with the other components, one or more graphical user interfaces (“GUIs”). In particular, the components can allow a user 110 to interact with a collection of display elements for a variety of purposes. In particular, FIGS. 3A-3E and the description that follows illustrate various example embodiments of the user interfaces and features that are in accordance with one or more embodiments of the present disclosure.

For example, FIG. 3A illustrates a user device 302 of a social networking system user (e.g., the user 110 of FIG. 1) that may implement one or more of the components or features of the communication system 100. As shown in FIG. 3A, in some embodiments, the user device 302 is a handheld device, such as a mobile phone device (e.g., a smartphone). As used herein, the term “handheld device” refers to a device sized and configured to be held/operated in a single hand of the user 110. In additional or alternative examples, however, any other suitable computing device, such as, but not limited to, a tablet device, larger wireless device, laptop or desktop computer, a personal digital assistant device, and/or any other suitable computing device can perform one or more of the processes and/or operations described herein.

The user device 302 includes a touch screen display 316 that can display user interfaces. Furthermore, the user device 302 receives and/or detects user input via the touch screen display 316. As used herein, a “touch screen display” refers to the display of a touch screen device. In one or more embodiments, a touch screen device may be the user device 302 with at least one surface upon which a user 110 may perform touch gestures (e.g., a laptop, a tablet computer, a personal digital assistant, a media player, a mobile phone, etc.). Additionally or alternatively, the user device 302 may include any other suitable input device, such as a touch pad or those described below with reference to FIG. 6.

As shown in FIG. 3A, the touch screen display 316 of the user device 302 displays a social networking application GUI 306a (e.g., provided by a social networking application installed on the user device 302). The social networking application GUI 306a displays a user's newsfeed 318. The newsfeed 318 includes content 350 (e.g., a post) associated with a third party merchant (i.e., “Solitude Camping”) that may be representative of the third party associated with the third party system 112 described above in regard to FIGS. 1-2D. The content 350 may include one or more interactive features whereby the user 110 can view and interact with the content 350. As illustrated in FIG. 3A, the content 350 may include details regarding an offer, images of a product associated with the offer, a service, and/or an attraction associated with the third party system 112 and at least one selectable element 322 to interact with the content 350 (e.g., a selectable element to receive more information and/or register for the offer).

Referring to FIGS. 3A and 3B together, the user device 302 and/or social networking application may detect a user interaction (e.g., clicking or tapping) with the at least one selectable element 322 of the content 350 via the touch screen display 316. As discussed in greater detail above in regard to FIGS. 2A-2D, in response to detecting a user interaction with the at least one selectable element 322 of the content 350, the social networking system 104 provides and the social networking application 106 of the user device 302 displays an electronic form 352 having a plurality of questions and/or fillable fields 354a, 354b, 354c. The plurality of fillable fields 354a, 354b, 354c (referred to collectively herein as “the plurality of fillable fields 354”) each include an input area for receiving input (e.g., responses) from the user. The user can interact with the electronic form 352 to provide one or more responses within the electronic form 352. Although, FIG. 3B provides examples for the plurality of fillable fields 354, one will appreciate that the electronic form 352 can include any number of additional or alternative fields to solicit any other information from the user as may suit a particular implementation. For example, the electronic 352 can solicit additional information regarding the user, the user's prior use of related products, the user's prior purchasing history of related products, the user's current purchasing interests, etc.

As mentioned above, when providing the electronic form 352, the social networking system 104 can prefill (e.g., include an expected response within) one or more of the plurality of fillable fields 354 of the electronic form 352 based on information available to the social networking system 104 (e.g., from a user profile) prior to providing the electronic form to the user. For example, the social networking system 104 can prefill one or more of the plurality of fillable fields 354 of the electronic form 352 according to any of the manners described above in regard to step 210 of FIG. 2A.

Moreover, as discussed above in regard to step 210 of FIG. 2A, the electronic form 352 can include a selectable option 356 to request or permit communication with the third party (e.g., be contacted by a representative of the third party). For example, as illustrated in FIG. 3B, in some embodiments, the electronic form can include a markable area (e.g., a check box or radio button) whereby the user can indicate, by marking or by not marking, that the user would like or would not like to communicate with the third party (e.g., via the messaging application 114). Also, as discussed above, in other embodiments, the electronic form 352 can include a question asking permission to contact the user (e.g., via the messaging application) and a correlating fillable field where the user 110 can include a response “YES” or “NO.”

Referring still to FIG. 3B, the user device 302 and social networking application 106 can detect one or more user inputs (e.g., responses) within the plurality of fillable fields 354 of the electronic form 352 and a selection of the selectable option 356 (e.g., indication or request) to communicate with the third party. In response to receiving the user responses and the request to communicate with the third party, the social networking system 104 generates a communication thread 358 and/or adds one or more messages to the communication thread 358 between the user and the third party, as shown in FIG. 3C. To illustrate, in one example, the social networking system 104 (or messaging system 103) creates new communication thread between the user and the third party and assigns a unique identifier to the new communication thread. In another example, if a communication thread between the user and the third party already exists, the social networking system (or messaging system 103) identifies the pre-existing communication thread (using a corresponding thread ID) and uses the identified communication thread to communicate with the user on behalf of the third party. For example, the system can provide one or more automated messages to the user by way of the communication thread and then facilitate subsequent communication between the third party and the user by way of the same communication thread.

As illustrated in FIG. 3C, in some embodiments, the communication thread 358 can be displayed within a messaging application (e.g., separate from or associated with the social networking application 106). Furthermore, the communication thread 358 can be displayed within a common window 360 for displaying messages from both of the user and the third party. Moreover, the graphical user interface can include an input area 362 for adding messages to the common thread. The graphical user interface can further include a plurality of selectable elements (e.g., for sending communications from the user, attaching content to a message, etc.).

As discussed above in regard to FIG. 2A-2D, the social networking system 104 can customize one or more automated messages and can add the customized messages to the communication thread 358. For example, after receiving input from the user via the electronic form 352, the social networking system 104 can generate a first automated message 358a and add the first automated message 358a to the communication thread 358 (e.g., to be sent to or accessed by the user). As shown, the first automated message 358a includes a welcome message (“Welcome to Solitude Camping!”) as well as a question for the user (“How can I help you?”). In response to the first automated message 358a, the user can provide a first response 358b. As shown, in the first response 358b, the user responds to the first automated message 358a by expressing interest in purchasing a tent (“I am interested in purchasing a new tent”).

As discussed above, the social networking system 104 can continue to communicate with the user by generating and providing additional automated messages to the user via the communication thread 358. As shown in FIG. 3D, for example, the social networking system 104 can generate a second automated message 358c and add it to the communication thread 358 in response to the first response 358b received from the user. In particular, based on the user's expressed interest in purchasing a tent, the social networking system 104 generates the second automated message 358c to obtain additional information regarding the type of tent of interest to the user. To illustrate, the second automated message 358c includes a question regarding the type of tent of interest to the user (“What type of tent are you looking for?”) as well as instructions for browsing through and selecting from a plurality of available options within the second automated message 358c (“Swipe through and select one of the options below”).

As mentioned above, the social networking system 104 can customize automated messages to include a variety of different types of content as well as interactive options for the user to respond to the automated messages. To illustrate, the second automated message 358c includes an interactive swipe feature, by which the user can navigate a plurality of images associated with different types of tents. In further embodiments, in addition to or in place of images, an automated message can include other content, such as video clips, audio clips, etc. using the interactive swipe feature of the second automated message 358c, navigate from the option displayed in FIG. 3D to any other available options. To illustrate, FIG. 3E illustrates the second automated message 358c after the user has navigated from an initially-displayed option (an option corresponding to “3 Man Tents”) to another available option (an option corresponding to “4 Man Tents”). After browsing the available options, the user can select the desired option by, for example, tapping on the image associated with the desired option within the second automated message 358c. Although FIGS. 3D-3E provide one example of an automated message including varieties of content and interactive features, one will appreciate the social networking system 104 can configure an automated message to include any other suitable graphical elements and/or interactive elements (e.g., scroll bars, radio buttons, icons, links, lists of options, etc.) as may suit a particular purpose and/or in order to obtain additional information from the user in a way that is user-friendly and engaging for the user.

As discussed above, once the communication thread 358 is ready for human interaction, the social networking system 104 can notify the third party and a representative of the third party can continue to communicate with the user by way of the communication thread 358. Whether a message is automated by the social networking system or composed by a human representative of the third party, its appearance in the communication thread 358 can be substantially the same. As such, the user is given the impression that all of the messages originate from a human representative of the third party.

In some embodiments, the social networking system 104 can create and customize automated messages to the user utilizing a Bot (e.g., an automated artificial intelligence messaging system). The Bot can function in accordance with Bot Logic (i.e., a Bot Engine) that includes the rules, machine learning models, and/or heuristics by which the Bot operates. In essence, the Bot Engine guides the Bot through various conversational paths in interacting with a user. In particular, at any point in a conversation with a user, the Bot Engine determines an intent of the user or one or more characteristics of a conversational situation and identifies an appropriate action to take to address the intent of the user or the specific situation. In other words, the Bot Engine can identify or predict the next action the Bot will need to execute at each step in a conversation based on rules and/or machine learning models.

As mentioned, the Bot Engine can guide the actions of a Bot in accordance with machine learning models. For example, the Bot Engine can train one or more conversation models using a training dataset including example conversations. The training dataset gives examples of at least some probable conversation paths, and based on the training dataset, the Bot Engine builds a machine learning model that overfits the training dataset. Put another way, the Bot Engine uses the conversations of the training dataset similar to rules. However, unlike rules, the example conversations can ignore each other, and when new conversations are added to the training dataset, there is no need to account for the previous stories. Accordingly, each time a new conversation is added to the dataset, the Bot Engine's machine learning model is rebuilt/updated to account for the conversational possibilities/paths represented by the new conversation. As one will appreciate, the training dataset can be specific to a particular merchant so that the machine learning model of the Bot Engine is specific to the conversational paths desired and anticipated by the merchant. In other words, the merchant can provide a training dataset of conversations between human representatives of the merchant and users, and the Bot Engine can train the machine learning model using the provided dataset. As such, the logic of the machine learning model will be tailored to the particular merchant.

As mentioned above, a Bot can operate in accordance with a corresponding Bot Engine or Bot logic. Although the principles described herein can be implemented in accordance with various Bot Engines, FIG. 4 illustrates one example of a rule-based Bot logic 400 that can guide a Bot through various conversational paths with a user. In other words, a system (e.g., the social networking system 104 or messaging system 103) can utilize the Bot logic of FIG. 4 to identify the appropriate actions to take at various steps in a conversation with a user. As shown in FIG. 4, the Bot logic 400 can include determining whether the user provided a response to each question of an electronic form (e.g., as described in more detail above), as shown in step 402. For example, the Bot can analyze the responses to an electronic form filled out by the user to determine if any information is missing. The Bot can further compare the received information to a list of information the third party requires before initiating human interaction with the user.

If the Bot determines that the user provided a response to each question of the electronic form, the Bot can provide at least one first automated message that pertains to a question, for which a response was received from the user, as shown in step 404 of FIG. 4. For example, if an answer from the user can indicate one of two possible results, the Bot can provide an automated message to determine which of the two results is correct. Furthermore, the Bot can customize the at least one first automated message in accordance with responses provided by the user. For example, the Bot can utilize the NLP system and NLG system described above in regard to FIGS. 2A-2D to customize the at least one first automated message. In other embodiments, the Bot logic 400 can define a specific automated message to provide at step 404.

If, on the other hand, the Bot determines that the user did not provide a response to at least one question of the electronic form, the Bot can provide at least one first automated message that pertains to a question, for which no response was received, as shown in step 406 of FIG. 4. Furthermore, the Bot can customize the at least one first automated message to accord with other responses provided by the user. For example, the Bot can utilize the NLP system and NLG system described above in regard to FIGS. 2A-2D to customize the at least one first automated message. In other embodiments, the Bot logic 400 can define a specific message to provide at step 406. In some embodiments, the Bot can repeat the step of providing at least one automated message that pertains to a question for which a response was not received until responses are received for each question of the electronic form.

Still referring to step 406 of FIG. 4, if the Bot receives responses for each question of the electronic form, the Bot can provide at least one first automated message that pertains to a question for which a response was received, as described above in regard to step 404 of FIG. 4. Conversely, if the user repeatedly refuses to provide responses to the questions, repeatedly provides unclear responses, or repeatedly asks for an administrator (e.g., a supervisor, representative, etc.) (referred to herein collectively as “Response C”), the Bot can trigger a notification to the third party system, as described above in regard to step 252 of FIG. 2D.

Referring again to step 404 of FIG. 4, if, in response to providing at least one first automated message, the Bot receives a first response (referred to hereinafter as “Response A”), the Bot can provide a series of automated messages pertaining to Response A as defined by the Bot logic 400, as shown in step 408 of FIG. 4. Furthermore, the Bot can customize each automated message of the series of automated messages to accord with one or more previous responses received from the user. In some embodiments, the Bot can utilize the NLP system and NLG system described above in regard to FIGS. 2A-2D to customize each automated message of the series of automated messages.

If, on the other hand, the Bot receives a second response (referred to hereinafter as “Response B”), the Bot can provide a series of automated messages pertaining to Response B, as shown in step 410 of FIG. 4. Furthermore, the Bot can customize each automated message of the series of automated messages to coincide with one or more previous responses received from the user 110. For example, the Bot can utilize a machine learning model or the NLP system and NLG system described above in regard to FIGS. 2A-2D to customize each automated message of the series of automated messages based on the responses from the user and/or the specifics of a particular conversational path.

Referring to steps 408 and 410 together, after providing the series of automated messages for a respective response (e.g., Response A and/or Response B), the Bot can trigger a notification to the third party. In other words, after receiving responses from the user in regard to the series of automated messages, the Bot can trigger the notification to a third party system, as shown in step 412 of FIG. 4. Further, while providing the series of automated messages for a respective response, the Bot can trigger the notification to the third party for any of the threshold events discussed above in regard to step 250 of FIG. 2D. In other words, the Bot logic 400 can define when the Bot should pass the conversation on to a representative of the third party.

Referring again to step 404, in some embodiments, the Bot can receive Response C (e.g., user repeatedly refuses to provide responses to the questions, repeatedly provides unclear responses, or repeatedly asks for an administrator) in response to providing at least one automated message. In response, the Bot can trigger the notification to the third party, as shown in step 412 of FIG. 4.

For purposes of facilitating explanation, the Bot is described as receiving one of three responses (e.g., Response A, Response B, and Response C). However, one of ordinary skill in the art will readily recognize that the Bot can receive any number of different responses, and the Bot can provide any number of different series of automated messages in response to the any number of different responses. Furthermore, one will appreciate that Bot logic 400 is merely a simplified example of how a Bot would determine what action to take at each step in a conversation. The Bot disclosed herein can operate using a variety of different Bot logics and corresponding heuristics.

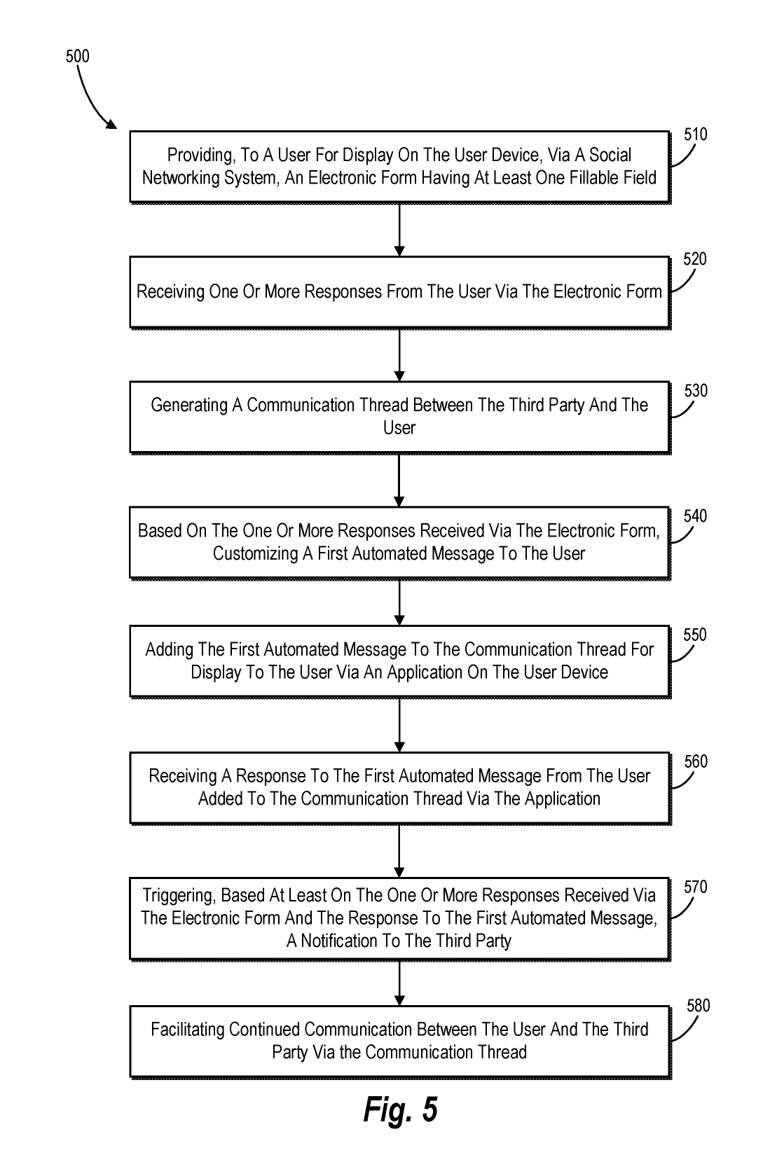

FIG. 5 illustrates a flowchart of one example method 500 of facilitating communications between a third party and a social networking system user. The method 500 can be implemented by a social networking system as described above. The method 500 involves an act 510 of providing an electronic form to a user. For example, act 510 can include providing, to a user for display on a user device, via a social networking system, an electronic form having at least one fillable field. In particular, act 510 can include providing an electronic form having a plurality of fillable fields. Additionally, act 510 can include any of the actions described above in regard to step 210 of FIG. 2A.

Additionally, the method 500 involves an act 520 of receiving a response from the user via the electronic form. Act 520, for example, can include receiving one or more responses from the user via the electronic form. In particular, the act 520 may include receiving a response from the user correlating to at least one first fillable field of the plurality of fillable fields and not receiving a response from the user correlating to at least one second fillable field of the plurality of fillable fields. Furthermore, act 520 can include any of the actions described above in regard to step 216 of FIG. 2A.

Furthermore, the method 500 involves an act 530 of generating a communication thread. For example, act 530 can include initiating a new communication thread and assigning the communication thread a unique thread ID. The act 530 can include generating a communication thread between the third party and the user. In particular, act 530 can include generating a communication thread between the third party and the user within a social networking application or a messaging application. Moreover, act 530 can include any of the actions described above in regard to step 218 of FIG. 2B.

The method 500 also involves an act 540 of customizing a message to the user 110. For example, act 540 can include, based on the one or more responses received via the electronic form, customizing a first automated message to the user. In particular, act 540 may include customizing the first automated message at least partially based on a user profile of the social networking system and associated with the user. Furthermore, act 540 may include customizing the at least one automated message to relate to the at least one second fillable field of the plurality of fillable fields for which a response from the user was not received. Additionally, act 540 can include any of the actions described above in regard to step 222 of FIG. 2B.

Moreover, the method 500 can further include act 550 of adding the message to the communication thread for display to the user. For example, act 550 can include adding the first automated message to the communication thread for display to the user via a messaging application on the user's device. Moreover, act 550 can include any of the actions described above in regard to step 226 of FIG. 2B.

Furthermore, the method 500 involves an act 560 of receiving a response from the user. For example, act 560 can include receiving a response to the first automated message from the user added to the communication thread via the messaging application. Moreover, act 560 can include any of the actions described above in regard to step 232 of FIG. 2C.

Additionally, the method 500 involves an act 570 of triggering a notification to the third party. For example, act 570 can include triggering, based at least on the one or more responses received via the electronic form and the response to the first automated message, a notification to a third party system or administrator associated with the third party. Moreover, act 570 may include triggering the notification after receiving a predetermined number of responses from the user. Likewise, act 570 can include triggering the notification after receiving a predetermined response from the user. Additionally, act 570 can include triggering the notification after providing a predetermined set of customizable automated messages to the user. Also, act 570 can include triggering the notification to an administrator page associated with the third party system 112 and within the social networking system. Moreover, act 570 can include any of the actions described above in regard to step 250 of FIG. 2D.

The method 500 further involves an act 580 of facilitating communication between the user and the third party. For example, act 580 can include facilitating continued communication between the user and the third party via the communication thread and/or messaging system and corresponding applications. In particular, act 580 may include enabling an administrator associated with the third party to add messages to the communication thread via a messaging application. Moreover, act 580 can include any of the actions described above in regard to step 254 of FIG. 2D.

Additionally, the method 500 can include, based on the received response to the first automated message, customizing one or more additional automated messages to the user, adding the one or more additional automated messages to the communication thread for display to the user via the messaging application on the user device, and receiving one or more additional responses to the one or more additional automated messages from the user added to the communication thread via the messaging application. Furthermore, the method 500 can include triggering, based at least partially on the one or more additional responses, the notification to an administrator associated with the third party. Moreover, the method 500 can include prefilling at least one fillable field of the electronic form based on a user profile of the social networking system and associated with the user. Additionally, the method 500 can include receiving, via the electronic form, a request to communicate with the third party system via the messaging application. Likewise, the method 500 can include tagging the communication thread between the third party system and the user with one or more tags based at least partially on the one or more responses received via the electronic form, the response to the at least one automated message, and the one or more additional responses.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 6 illustrates a block diagram of exemplary computing device 600 that may be configured to perform one or more of the processes described above. One will appreciate that one or more computing devices such as the computing device 600 may implement the communication system 100. As shown by FIG. 6, the computing device 600 can comprise a processor 602, a memory 604, a storage device 606, an I/O interface 608, and a communication interface 610, which may be communicatively coupled by way of a communication infrastructure 612. While an exemplary computing device 600 is shown in FIG. 6, the components illustrated in FIG. 6 are not intended to be limiting. Additional or alternative components may be used in other embodiments. Furthermore, in certain embodiments, the computing device 600 can include fewer components than those shown in FIG. 6. Components of the computing device 600 shown in FIG. 6 will now be described in additional detail.

In one or more embodiments, the processor 602 includes hardware for executing instructions, such as those making up a computer program. As an example and not by way of limitation, to execute instructions, the processor 602 may retrieve (or fetch) the instructions from an internal register, an internal cache, the memory 604, or the storage device 606 and decode and execute them. In one or more embodiments, the processor 602 may include one or more internal caches for data, instructions, or addresses. As an example and not by way of limitation, the processor 602 may include one or more instruction caches, one or more data caches, and one or more translation lookaside buffers (TLBs). Instructions in the instruction caches may be copies of instructions in the memory 604 or the storage 606.

The memory 604 may be used for storing data, metadata, and programs for execution by the processor(s). The memory 604 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 604 may be internal or distributed memory.

The storage device 606 includes storage for storing data or instructions. As an example and not by way of limitation, storage device 606 can comprise a non-transitory storage medium described above. The storage device 606 may include a hard disk drive (HDD), a floppy disk drive, flash memory, an optical disc, a magneto-optical disc, magnetic tape, or a Universal Serial Bus (USB) drive or a combination of two or more of these. The storage device 606 may include removable or non-removable (or fixed) media, where appropriate. The storage device 606 may be internal or external to the computing device 600. In one or more embodiments, the storage device 606 is non-volatile, solid-state memory. In other embodiments, the storage device 606 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

The I/O interface 608 allows a user to provide input to, receive output from, and otherwise transfer data to and receive data from computing device 600. The I/O interface 608 may include a mouse, a keypad or a keyboard, a touch screen, a camera, an optical scanner, network interface, modem, other known I/O devices or a combination of such I/O interfaces. The I/O interface 608 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 608 is configured to provide graphical data to a display for presentation to a user. The graphical data may be representative of one or more graphical user interfaces and/or any other graphical content as may serve a particular implementation.

The communication interface 610 can include hardware, software, or both. In any event, the communication interface 610 can provide one or more interfaces for communication (such as, for example, packet-based communication) between the computing device 600 and one or more other computing devices or networks. As an example and not by way of limitation, the communication interface 610 may include a network interface controller (NIC) or network adapter for communicating with an Ethernet or other wire-based network or a wireless NIC (WNIC) or wireless adapter for communicating with a wireless network, such as a WI-FI.

Additionally or alternatively, the communication interface 610 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the communication interface 610 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, the communication interface 610 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 612 may include hardware, software, or both that couples components of the computing device 600 to each other. As an example and not by way of limitation, the communication infrastructure 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

As mentioned above, the system 100 can comprise a social networking system 104. A social networking system 104 may enable its users (such as persons or organizations) to interact with the system and with each other. The social networking system 104 may, with input from a user, create and store in the social networking system 104 a user profile associated with the user. The user profile may include demographic information, communication-channel information, and information on personal interests of the user. The social networking system 104 may also, with input from a user, create and store a record of relationships of the user with other users of the social networking system 104, as well as provide services (e.g., posts, photo-sharing, event organization, messaging, games, or advertisements) to facilitate social interaction between or among users.

The social networking system 104 may store records of users and relationships between users in a social graph comprising a plurality of nodes and a plurality of edges connecting the nodes. The nodes may comprise a plurality of user nodes and a plurality of concept nodes. A user node of the social graph may correspond to a user of the social networking system 104. A user may be an individual (human user), an entity (e.g., an enterprise, business, or third party application), or a group (e.g., of individuals or entities). A user node corresponding to a user may comprise information provided by the user and information gathered by various systems, including the social networking system 104.

For example, the user may provide his or her name, profile picture, city of residence, contact information, birth date, gender, marital status, family status, employment, educational background, preferences, interests, and other demographic information to be included in the user node. Each user node of the social graph may have a corresponding web page (typically known as a profile page). In response to a request including a user name, the social networking system 104 can access a user node corresponding to the user name, and construct a profile page including the name, a profile picture, and other information associated with the user. A profile page of a first user may display to a second user all or a portion of the first user's information based on one or more privacy settings by the first user and the relationship between the first user and the second user.

A concept node may correspond to a concept of the social networking system 104. For example, a concept can represent a real-world entity, such as a movie, a song, a sports team, a celebrity, a group, a restaurant, or a place or a location. An administrative user of a concept node corresponding to a concept may create or update the concept node by providing information of the concept (e.g., by filling out an online form), causing the social networking system 104 to associate the information with the concept node. For example and without limitation, information associated with a concept can include a name or a title, one or more images (e.g., an image of cover page of a book), a web site (e.g., an URL address) or contact information (e.g., a phone number, an email address). Each concept node of the social graph may correspond to a web page. For example, in response to a request including a name, the social networking system 104 can access a concept node corresponding to the name, and construct a web page including the name and other information associated with the concept.

An edge between a pair of nodes may represent a relationship between the pair of nodes. For example, an edge between two user nodes can represent a friendship between two users. For another example, the social networking system 104 may construct a web page (or a structured document) of a concept node (e.g., a restaurant, a celebrity), incorporating one or more selectable option or selectable elements (e.g., “like”, “check in”) in the web page. A user can access the page using a web browser hosted by the user's client device and select a selectable option or selectable element, causing the client device to transmit to the social networking system 104 a request to create an edge between a user node of the user and a concept node of the concept, indicating a relationship between the user and the concept (e.g., the user checks in a restaurant, or the user “likes” a celebrity).

As an example, a user may provide (or change) his or her city of residence, causing the social networking system 104 to create an edge between a user node corresponding to the user and a concept node corresponding to the city declared by the user as his or her city of residence. In addition, the degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.”

A social networking system 104 may support a variety of applications, such as photo sharing, on-line calendars and events, gaming, instant messaging, and advertising. For example, the social networking system 104 may also include media sharing capabilities. Also, the social networking system 104 may allow users to post photographs and other multimedia content items to a user's profile page (typically known as “wall posts” or “timeline posts”) or in a photo album, both of which may be accessible to other users of the social networking system 104 depending upon the user's configured privacy settings. The social networking system 104 may also allow users to configure events. For example, a first user may configure an event with attributes including time and date of the event, location of the event and other users invited to the event. The invited users may receive invitations to the event and respond (such as by accepting the invitation or declining it). Furthermore, the social networking system 104 may allow users to maintain a personal calendar. Similarly to events, the calendar entries may include times, dates, locations and identities of other users.

FIG. 7 illustrates an example network environment 700 of a social networking system 702 (which may represent an example of social networking system 104). Network environment 700 includes a client device 706, a social networking system 702, and a third party system 708 connected to each other by a network 704. Although FIG. 7 illustrates a particular arrangement of client device 706, social networking system 702, third party system 708, and network 704, this disclosure contemplates any suitable arrangement of client device 706, social networking system 702, third party system 708, and network 704. As an example and not by way of limitation, two or more of client device 706, social networking system 702, and third party system 708 may be connected to each other directly, bypassing network 704. As another example, two or more of client device 706, social networking system 702, and third party system 708 may be physically or logically co-located with each other in whole or in part. Moreover, although FIG. 7 illustrates a particular number of client devices 706, social networking systems 702, third party system 708, and networks 704, this disclosure contemplates any suitable number of client devices 706, social networking systems 702, third party system 708, and networks 704. As an example and not by way of limitation, network environment 700 may include multiple client device 706, social networking systems 702, third party system 708, and networks 704.

This disclosure contemplates any suitable network 704. As an example and not by way of limitation, one or more portions of network 704 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 704 may include one or more networks 704.

Links may connect client device 706, social networking system 702, and third party system 708 to communication network 704 or to each other. This disclosure contemplates any suitable links. In particular embodiments, one or more links include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 700. One or more first links may differ in one or more respects from one or more second links.

In particular embodiments, client device 706 may be an electronic device including hardware, software, or embedded logic components or a combination of two or more such components and capable of carrying out the appropriate functionalities implemented or supported by client device 706. As an example and not by way of limitation, a client device 706 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client devices 706. A client device 706 may enable a network user at client device 706 to access network 704. A client device 706 may enable its user to communicate with other users at other client devices 706.

In particular embodiments, client device 706 may include a web browser, such as MICROSOFT INTERNET EXPLORER, GOOGLE CHROME or MOZILLA FIREFOX, and may have one or more add-ons, plugins, or other extensions, such as TOOLBAR or YAHOO TOOLBAR. A user at client device 706 may enter a Uniform Resource Locator (URL) or other address directing the web browser to a particular server (such as server, or a server associated with a third party system 708), and the web browser may generate a Hyper Text Transfer Protocol (HTTP) request and communicate the HTTP request to server. The server may accept the HTTP request and communicate to client device 706 one or more Hyper Text Markup Language (HTML) files responsive to the HTTP request. Client device 706 may render a web page based on the HTML files from the server for presentation to the user. This disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

In particular embodiments, social networking system 702 may be a network-addressable computing system that can host an online social network. Social networking system 702 may generate, store, receive, and send social-networking data, such as, for example, user-profile data, concept-profile data, social-graph information, or other suitable data related to the online social network. Social networking system 702 may be accessed by the other components of network environment 700 either directly or via network 704. In particular embodiments, social networking system 702 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, social networking system 702 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 706, a social networking system 702, or a third party system 708 to manage, retrieve, modify, add, or delete, the information stored in data store.

In particular embodiments, social networking system 702 may store one or more social graphs in one or more data stores. In particular embodiments, a social graph may include multiple nodes—which may include multiple user nodes (each corresponding to a particular user) or multiple concept nodes (each corresponding to a particular concept)—and multiple edges connecting the nodes. Social networking system 702 may provide users of the online social network the ability to communicate and interact with other users. In particular embodiments, users may join the online social network via social networking system 702 and then add connections (e.g., relationships) to a number of other users of social networking system 702 whom they want to be connected to. Herein, the term “friend” may refer to any other user of social networking system 702 with whom a user has formed a connection, association, or relationship via social networking system 702.

In particular embodiments, social networking system 702 may provide users with the ability to take actions on various types of items or objects, supported by social networking system 702. As an example and not by way of limitation, the items and objects may include groups or social networks to which users of social networking system 702 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social networking system 702 or by an external system of third party system 708, which is separate from social networking system 702 and coupled to social networking system 702 via a network 704.

In particular embodiments, social networking system 702 may be capable of linking a variety of entities. As an example and not by way of limitation, social networking system 702 may enable users to interact with each other as well as receive content from third party system 708 or other entities, or to allow users to interact with these entities through an application programming interfaces (API) or other communication channels.

In particular embodiments, a third party system 708 may include one or more types of servers, one or more data stores, one or more interfaces, including but not limited to APIs, one or more web services, one or more content sources, one or more networks, or any other suitable components, e.g., that servers may communicate with. A third party system 708 may be operated by a different entity from an entity operating social networking system 702. In particular embodiments, however, social networking system 702 and third party system 708 may operate in conjunction with each other to provide social-networking services to users of social networking system 702 or third party system 708. In this sense, social networking system 702 may provide a platform, or backbone, which other systems, such as third party system 708, may use to provide social-networking services and functionality to users across the Internet.

In particular embodiments, a third party system 708 may include a third party content object provider. A third party content object provider may include one or more sources of content objects, which may be communicated to a client device 706. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social networking system 702 also includes user-generated content objects, which may enhance a user's interactions with social networking system 702. User-generated content may include anything a user can add, upload, send, or “post” to social networking system 702. As an example and not by way of limitation, a user communicates posts to social networking system 702 from a client device 706. Posts may include data such as status updates or other textual data, location information, photos, videos, links, music or other similar data or media. Content may also be added to social networking system 702 by a third party through a “communication channel,” such as a newsfeed or stream.

In particular embodiments, social networking system 702 may include a variety of servers, sub-systems, programs, modules, logs, and data stores. In particular embodiments, social networking system 702 may include one or more of the following: a web server, action logger, API-request server, relevance-and-ranking engine, content-object classifier, notification controller, action log, third party-content-object-exposure log, inference module, authorization/privacy server, search module, advertisement-targeting module, user-interface module, user-profile store, connection store, third party content store, or location store. Social networking system 702 may also include suitable components such as network interfaces, security mechanisms, load balancers, failover servers, management-and-network-operations consoles, other suitable components, or any suitable combination thereof. In particular embodiments, social networking system 702 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social networking system 702 to one or more client devices 706 or one or more third party system 708 via network 704. The web server may include a mail server or other messaging functionality for receiving and routing messages between social networking system 702 and one or more client devices 706. An API-request server may allow a third party system 708 to access information from social networking system 702 by calling one or more APIs. An action logger may be used to receive communications from a web server about a user's actions on or off social networking system 702. In conjunction with the action log, a third party-content-object log may be maintained of user exposures to third party-content objects. A notification controller may provide information regarding content objects to a client device 706. Information may be pushed to a client device 706 as notifications, or information may be pulled from client device 706 responsive to a request received from client device 706. Authorization servers may be used to enforce one or more privacy settings of the users of social networking system 702. A privacy setting of a user determines how particular information associated with a user can be shared. The authorization server may allow users to opt in to or opt out of having their actions logged by social networking system 702 or shared with other systems (e.g., third party system 708), such as, for example, by setting appropriate privacy settings. Third party-content-object stores may be used to store content objects received from third parties, such as a third party system 708. Location stores may be used for storing location information received from client devices 706 associated with users. Advertisement-pricing modules may combine social information, the current time, location information, or other suitable information to provide relevant advertisements, in the form of notifications, to a user.

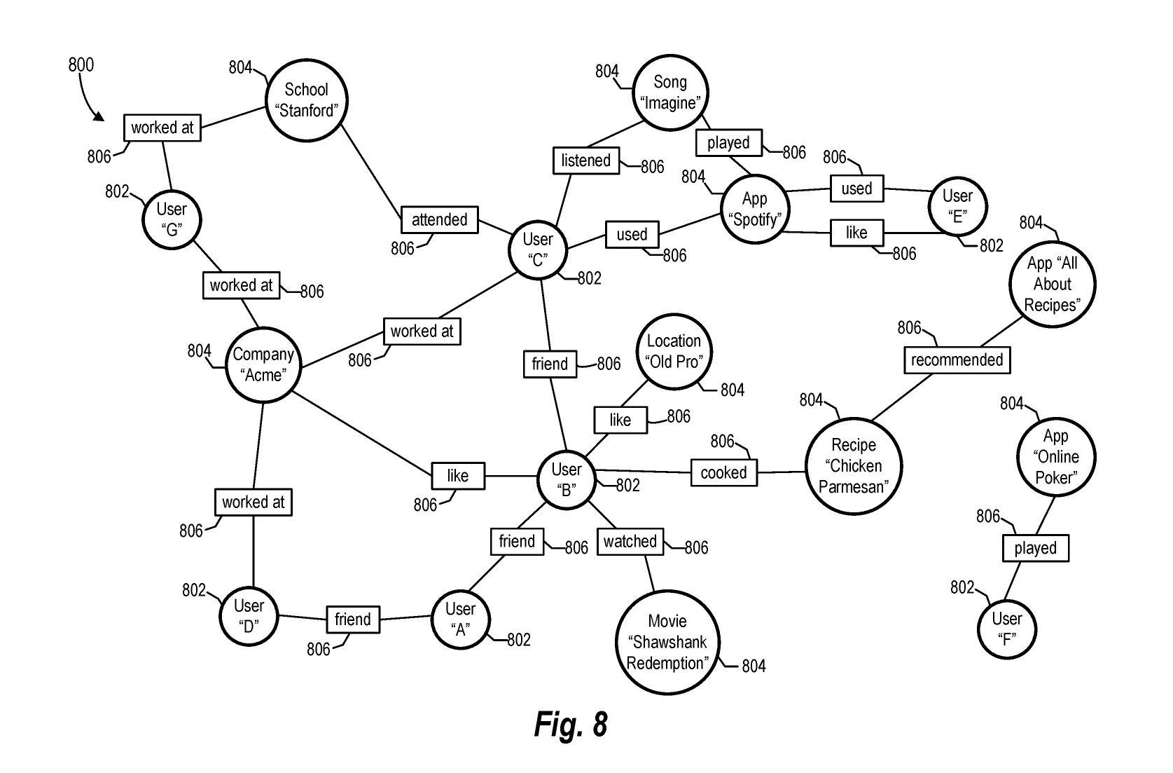

FIG. 8 illustrates example social graph 800. Referring to FIGS. 7 and 8 together, in particular embodiments, social networking system 702 may store one or more social graphs 800 in one or more data stores. In particular embodiments, social graph 800 may include multiple nodes—which may include multiple user nodes 802 or multiple concept nodes 804—and multiple edges 806 connecting the nodes. Example social graph 800 illustrated in FIG. 8 is shown, for didactic purposes, in a two-dimensional visual map representation. In particular embodiments, a social networking system 702, client device 706, or third party system 708 may access social graph 800 and related social-graph information for suitable applications. The nodes and edges of social graph 800 may be stored as data objects, for example, in a data store (such as a social-graph database). Such a data store may include one or more searchable or query able indexes of nodes or edges of social graph 800.

In particular embodiments, a user node 802 may correspond to a user of social networking system 702. As an example and not by way of limitation, a user may be an individual (human user), an entity (e.g., an enterprise, business, or third party application), or a group (e.g., of individuals or entities) that interacts or communicates with or over social networking system 702. In particular embodiments, when a user registers for an account with social networking system 702, social networking system 702 may create a user node 802 corresponding to the user, and store the user node 802 in one or more data stores. Users and user nodes 802 described herein may, where appropriate, refer to registered users and user nodes 802 associated with registered users. In addition or as an alternative, users and user nodes 802 described herein may, where appropriate, refer to users that have not registered with social networking system 702. In particular embodiments, a user node 802 may be associated with information provided by a user or information gathered by various systems, including social networking system 702. As an example and not by way of limitation, a user may provide his or her name, profile picture, contact information, birth date, sex, marital status, family status, employment, education background, preferences, interests, or other demographic information. In particular embodiments, a user node 802 may be associated with one or more data objects corresponding to information associated with a user. In particular embodiments, a user node 802 may correspond to one or more web pages.

In particular embodiments, a concept node 804 may correspond to a concept. As an example and not by way of limitation, a concept may correspond to a place (such as, for example, a movie theater, restaurant, landmark, or city); a website (such as, for example, a website associated with social-network system 702 or a third party website associated with a web-application server); an entity (such as, for example, a person, business, group, sports team, or celebrity); a resource (such as, for example, an audio file, video file, digital photo, text file, structured document, or application) which may be located within social networking system 702 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 804 may be associated with information of a concept provided by a user or information gathered by various systems, including social networking system 702. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 804 may be associated with one or more data objects corresponding to information associated with concept node 804. In particular embodiments, a concept node 804 may correspond to one or more web pages.

In particular embodiments, a node in social graph 800 may represent or be represented by a web page (which may be referred to as a “profile page”). Profile pages may be hosted by or accessible to social networking system 702. Profile pages may also be hosted on third party websites associated with a third party server 708. As an example and not by way of limitation, a profile page corresponding to a particular external web page may be the particular external web page and the profile page may correspond to a particular concept node 804. Profile pages may be viewable by all or a selected subset of other users. As an example and not by way of limitation, a user node 802 may have a corresponding user-profile page in which the corresponding user may add content, make declarations, or otherwise express himself or herself. As another example and not by way of limitation, a concept node 804 may have a corresponding concept-profile page in which one or more users may add content, make declarations, or express themselves, particularly in relation to the concept corresponding to concept node 804.

In particular embodiments, a concept node 804 may represent a third party web page or resource hosted by a third party system 708. The third party web page or resource may include, among other elements, content, a selectable or other icon, or other inter-actable object (which may be implemented, for example, in JavaScript, AJAX, or PHP codes) representing an action or activity. As an example and not by way of limitation, a third party web page may include a selectable icon such as “like,” “check in,” “eat,” “recommend,” or another suitable action or activity. A user viewing the third party web page may perform an action by selecting one of the icons (e.g., “eat”), causing a client device 806 to send to social networking system 702 a message indicating the user's action. In response to the message, social networking system 702 may create an edge (e.g., an “eat” edge) between a user node 802 corresponding to the user and a concept node 804 corresponding to the third party web page or resource and store edge 806 in one or more data stores.

In particular embodiments, a pair of nodes in social graph 800 may be connected to each other by one or more edges 806. An edge 806 connecting a pair of nodes may represent a relationship between the pair of nodes. In particular embodiments, an edge 806 may include or represent one or more data objects or attributes corresponding to the relationship between a pair of nodes. As an example and not by way of limitation, a first user may indicate that a second user is a “friend” of the first user. In response to this indication, social networking system 702 may send a “friend request” to the second user. If the second user confirms the “friend request,” social networking system 702 may create an edge 806 connecting the first user's user node 802 to the second user's user node 802 in social graph 800 and store edge 806 as social-graph information in one or more of data stores. In the example of FIG. 8, social graph 800 includes an edge 806 indicating a friend relation between user nodes 802 of user “A” and user “B” and an edge indicating a friend relation between user nodes 802 of user “C” and user “B.” Although this disclosure describes or illustrates particular edges 806 with particular attributes connecting particular user nodes 802, this disclosure contemplates any suitable edges 806 with any suitable attributes connecting user nodes 802. As an example and not by way of limitation, an edge 806 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 800 by one or more edges 806.

In particular embodiments, an edge 806 between a user node 802 and a concept node 804 may represent a particular action or activity performed by a user associated with user node 802 toward a concept associated with a concept node 804. As an example and not by way of limitation, as illustrated in FIG. 8, a user may “like,” “attended,” “played,” “listened,” “cooked,” “worked at,” or “watched” a concept, each of which may correspond to an edge type or subtype. A concept-profile page corresponding to a concept node 804 may include, for example, a selectable “check in” icon (such as, for example, a clickable “check in” icon) or a selectable “add to favorites” icon. Similarly, after a user clicks these icons, social networking system 702 may create a “favorite” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, social networking system 702 may create a “listened” edge 806 and a “used” edge (as illustrated in FIG. 8) between user nodes 802 corresponding to the user and concept nodes 804 corresponding to the song and application to indicate that the user listened to the song and used the application. Moreover, social networking system 702 may create a “played” edge 806 (as illustrated in FIG. 8) between concept nodes 804 corresponding to the song and the application to indicate that the particular song was played by the particular application. In this case, “played” edge 806 corresponds to an action performed by an external application (SPOTIFY) on an external audio file (the song “Imagine”). Although this disclosure describes particular edges 806 with particular attributes connecting user nodes 802 and concept nodes 804, this disclosure contemplates any suitable edges 806 with any suitable attributes connecting user nodes 802 and concept nodes 804. Moreover, although this disclosure describes edges between a user node 802 and a concept node 804 representing a single relationship, this disclosure contemplates edges between a user node 802 and a concept node 804 representing one or more relationships. As an example and not by way of limitation, an edge 806 may represent both that a user likes and has used at a particular concept. Alternatively, another edge 806 may represent each type of relationship (or multiples of a single relationship) between a user node 802 and a concept node 804 (as illustrated in FIG. 8 between user node 802 for user “E” and concept node 804 for “SPOTIFY”).

In particular embodiments, social networking system 702 may create an edge 806 between a user node 802 and a concept node 804 in social graph 800. As an example and not by way of limitation, a user viewing a concept-profile page (such as, for example, by using a web browser or a special-purpose application hosted by the user's client device 706) may indicate that he or she likes the concept represented by the concept node 804 by clicking or selecting a “Like” icon, which may cause the user's client device 706 to send to social networking system 702 a message indicating the user's liking of the concept associated with the concept-profile page. In response to the message, social networking system 702 may create an edge 806 between user node 802 associated with the user and concept node 804, as illustrated by “like” edge 806 between the user and concept node 804. In particular embodiments, social networking system 702 may store an edge 806 in one or more data stores. In particular embodiments, an edge 806 may be automatically formed by social networking system 702 in response to a particular user action. As an example and not by way of limitation, if a first user uploads a picture, watches a movie, or listens to a song, an edge 806 may be formed between user node 802 corresponding to the first user and concept nodes 804 corresponding to those concepts. Although this disclosure describes forming particular edges 806 in particular manners, this disclosure contemplates forming any suitable edges 806 in any suitable manner.

In particular embodiments, an advertisement may be text (which may be HTML-linked), one or more images (which may be HTML-linked), one or more videos, audio, one or more ADOBE FLASH files, a suitable combination of these, or any other suitable advertisement in any suitable digital format presented on one or more web pages, in one or more e-mails, or in connection with search results requested by a user. In addition or as an alternative, an advertisement may be one or more sponsored stories (e.g., a news-feed or ticker item on social networking system 702). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results page, where sponsored content is promoted over non-sponsored content.

In particular embodiments, an advertisement may be requested for display within social-networking-system web pages, third party web pages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, social networking system 702 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through social networking system 702) or RSVP (e.g., through social networking system 702) to an event associated with the advertisement. In addition or as an alternative, an advertisement may include social-networking-system context directed to the user. As an example and not by way of limitation, an advertisement may display information about a friend of the user within social networking system 702 who has taken an action associated with the subject matter of the advertisement.

In particular embodiments, social networking system 702 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third party systems 808 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social networking system 702 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated based at least in part on the history of the user's actions. Coefficients may be used to predict any number of actions, which may be within or outside of the online social network. As an example and not by way of limitation, these actions may include various types of communications, such as sending messages, posting content, or commenting on content; various types of an observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social networking system 702 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social networking system 702 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social networking system 702 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social networking system 702 may calculate a coefficient based on a user's actions. Social networking system 702 may monitor such actions on the online social network, on a third party system 808, on other suitable systems, or any combination thereof. Any suitable type of user actions may be tracked or monitored. Typical user actions include viewing profile pages, creating or posting content, interacting with content, joining groups, listing and confirming attendance at events, checking-in at locations, liking particular pages, creating pages, and performing other tasks that facilitate social action. In particular embodiments, social networking system 702 may calculate a coefficient based on the user's actions with particular types of content. The content may be associated with the online social network, a third party system 808, or another suitable system. The content may include users, profile pages, posts, news stories, headlines, instant messages, chat room conversations, emails, advertisements, pictures, video, music, other suitable objects, or any combination thereof. Social networking system 702 may analyze a user's actions to determine whether one or more of the actions indicate an affinity for subject matter, content, other users, and so forth. As an example and not by way of limitation, if a user may make frequently posts content related to “coffee” or variants thereof, social networking system 702 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social networking system 702 may calculate a coefficient based on the type of relationship between particular objects. Referencing the social graph 800, social networking system 702 may analyze the number and/or type of edges 806 connecting particular user nodes 802 and concept nodes 804 when calculating a coefficient. As an example and not by way of limitation, user nodes 802 that are connected by a spouse-type edge (representing that the two users are married) may be assigned a higher coefficient than a user nodes 802 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in first photo, but merely likes a second photo, social networking system 702 may determine that the user has a higher coefficient with respect to the first photo than the second photo because having a tagged-in-type relationship with content may be assigned a higher weight and/or rating than having a like-type relationship with content. In particular embodiments, social networking system 702 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social networking system 702 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 800. As an example and not by way of limitation, social-graph entities that are closer in the social graph 800 (i.e., fewer degrees of separation) may have a higher coefficient than entities that are further apart in the social graph 800.

In particular embodiments, social networking system 702 may calculate a coefficient based on location information. Objects that are geographically closer to each other may be considered to be more related, or of more interest, to each other than more distant objects. In particular embodiments, the coefficient of a user towards a particular object may be based on the proximity of the object's location to a current location associated with the user (or the location of a client device 806 of the user). A first user may be more interested in other users or concepts that are closer to the first user. As an example and not by way of limitation, if a user is one mile from an airport and two miles from a gas station, social networking system 702 may determine that the user has a higher coefficient for the airport than the gas station based on the proximity of the airport to the user.

In particular embodiments, social networking system 702 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social networking system 702 may provide information that is relevant to user's interests and current circumstances, increasing the likelihood that they will find such information of interest. In particular embodiments, social networking system 702 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social networking system 702 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social networking system 702 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third party system 708 (e.g., via an API or other communication channel), or from another suitable system. In response to the request, social networking system 702 may calculate the coefficient (or access the coefficient information if it has previously been calculated and stored). In particular embodiments, social networking system 702 may measure an affinity with respect to a particular process. Different processes (both internal and external to the online social network) may request a coefficient for a particular object or set of objects. Social networking system 702 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, field 1 Oct. 2012, each of which is incorporated by reference.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 804 corresponding to a particular photo may have a privacy setting specifying that the photo may only be accessed by users tagged in the photo and their friends. In particular embodiments, privacy settings may allow users to opt in or opt out of having their actions logged by social networking system 702 or shared with other systems (e.g., third party system 808). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third party systems 808, particular applications (e.g., third party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers may be authorization/privacy servers for enforcing privacy settings. In response to a request from a user (or other entity) for a particular object stored in a data store, social networking system 702 may send a request to the data store for the object. The request may identify the user associated with the request and may only be sent to the user (or a client device 806 of the user) if the authorization server determines that the user is authorized to access the object based on the privacy settings associated with the object. If the requesting user is not authorized to access the object, the authorization server may prevent the requested object from being retrieved from the data store, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

The foregoing specification is described with reference to specific exemplary embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method comprising:
providing, to a user for display on a user device, via a social networking system, an electronic form having at least one fillable field;
receiving one or more responses from the user via the electronic form;
generating a communication thread between the third party and the user;
based on the one or more responses received via the electronic form, customizing a first automated message to the user;
adding the first automated message to the communication thread for display to the user via an application on the user device;
receiving a response to the first automated message from the user added to the communication thread via the application;
triggering, based at least on the one or more responses received via the electronic form and the response to the first automated message, a notification to the third party; and
facilitating continued communication between the user and the third party via the communication thread.

2. The method of claim 1, further comprising:
based on the received response to the first automated message, customizing one or more additional automated messages to the user;
adding the one or more additional automated messages to the communication thread for display to the user via the application on the user device; and
receiving one or more additional responses to the one or more additional automated messages from the user added to the communication thread via the application.

3. The method of claim 2, further comprising triggering, based at least partially on the one or more additional responses, the notification to an administrator associated with the third party.

4. The method of claim 1, wherein customizing a first automated message to the user comprises customizing the first automated message at least partially based on a user profile of the social networking system and associated with the user.

5. The method of claim 1, further comprising prefilling at least one fillable field of the electronic form based on a user profile of the social networking system and associated with the user.

6. The method of claim 1, wherein triggering a notification to an administrator associated with the third party comprises triggering the notification after receiving a predetermined number of responses from the user.

7. The method of claim 1, wherein triggering a notification to an administrator associated with the third party comprises triggering the notification after receiving a predetermined response from the user.

8. The method of claim 1, wherein triggering a notification to an administrator associated with the third party comprises triggering the notification after providing a predetermined set of customizable automated messages to the user.

9. A system comprising:
at least one processor; and
at least one non-transitory computer-readable storage medium storing instructions thereon that, when executed by the at least one processor, cause the system to:
provide to a user for display on a user device, via a social networking system, content associated with a third party;
in response to a user interaction with the content, provide to the user for display on a user device an electronic form having at least one fillable field;
receive one or more responses from the user via the electronic form;
generate a communication thread between the third party and the user;
based on the one or more responses received via the electronic form, customize at least one automated message to the user;
add the at least one automated message to the communication thread for display to the user via an application on the user device;
based on a response to the at least one automated message, customizing one or more additional automated messages to the user;
add the one or more additional automated messages to the communication thread for display to the user via the application on the user device;
receiving one or more additional responses to the one or more additional automated messages from the user added to the communication thread via the application;
triggering, based at least on one the or more responses received via the electronic form, the response to the at least one automated message, and the one or more additional responses, a notification to an administrator associated with the third party; and
facilitating continued communication between the user and the administrator via the communication thread.

10. The system of claim 9, wherein facilitating continued communication between the user and the administrator comprises enabling the administrator to add messages to the communication thread via the application.

11. The system of claim 9, further comprising instructions that, when executed by the at least one processor, cause the system to receive, via the electronic form, a request to communicate with the third party via the application.

12. The system of claim 9, further comprising instructions that, when executed by the at least one processor, cause the system to customize the at least one automated message to the user to include one or more of multi-select options, payment options, video content, or audio content.

13. The system of claim 12, wherein receiving one or more responses from the user via the electronic form comprises receiving a response from the user correlating to at least one first fillable field of the plurality of fillable fields and not receiving a response from the user correlating to at least one second fillable field of the plurality of fillable fields.

14. The system of claim 13, wherein customizing at least one automated message to the user comprises customizing the at least one automated message to relate to the at least one second fillable field of the plurality of fillable fields for which a response from the user was not received.

15. The system of claim 9, further comprising instructions that, when executed by the at least one processor, cause the system to tag the communication thread between the third party and the user with one or more tags based at least partially on the one or more responses received via the electronic form, the response to the at least one automated message, and the one or more additional responses.

16. A non-transitory computer readable medium storing instructions thereon that, when executed by at least one processor, cause the at least one processor to perform steps comprising:
providing to a user for display on a user device, via a social networking system, content associated with a third party;
in response to a user interaction with the content, generating a communication thread between the third party and the user;
customizing a series of automated messages to the user;
adding the series of automated messages to the communication thread for display to the user via an application on the user device;
receiving one or more responses to the series of automated messages from the user added to the communication thread via the application;
triggering, based at least on the one or more responses to the set of automated messages, a notification to an administrator associated with the third party; and
facilitating continued communication between the user and the administrator via the communication thread.

17. The non-transitory computer readable medium of claim 16, further comprising instructions that, when executed by the at least one processor, cause the system to tag the communication thread with one or more tags based at least partially on the content associated with the third party and provided to the user and the one or more responses to the series of automated messages.

18. The non-transitory computer readable medium of claim 16, wherein adding the series of automated messages to the communication thread for display to the user via an application of the user device comprises adding the series of automated messages to the communication thread for display to the user via a messaging application on the user device.

19. The non-transitory computer readable medium of claim 16, wherein triggering a notification to an administrator associated with the third party comprises triggering the notification to an administrator page associated with the third party and within the social networking system.

20. The non-transitory computer readable medium of claim 16, wherein customizing the series of automated messages comprises customizing the set of automated messages at least partially based on a user profile of the social networking system and associated with the user.
